(19) United States
(12) Patent Application Publication
(10) Pub. No.: US 2011/0199296 A1
(43) Pub. Date: Aug. 18, 2011

(54) SINGLE WRIST USER INPUT SYSTEM

(76) Inventor: Samuel K. Simpson, Santa Monica, CA (US)

(21) Appl. No.: 12/731,158

(22) Filed: Mar. 25, 2010

Related U.S. Application Data
(63) Continuation-in-part of application No. 12/708,201, filed on Feb. 18, 2010.

(51) Int. Cl. G09G 5/08

(52) U.S. Cl. 345/157

(57) ABSTRACT

A single wrist user input system includes a wrist band that conforms to a single wrist of a user. Further, the single wrist user input system includes a motion tracking sensor that tracks aerial motion of the single wrist of the user as aerial motion data. In addition, the single wrist user input system includes a rotational sensor that tracks rotational movement of the single wrist of the user as rotational movement data. The single wrist user input system also includes a receiver that receives the aerial motion data and the rotational movement data to provide the aerial motion data and the rotational movement data to the computing device.

### RELATED APPLICATIONS

This application is a Continuation-In-Part application of U.S. patent application Ser. No. 12/708,201, filed on Feb. 18, 2010 and entitled DUAL WRIST USER INPUT SYSTEM, which is hereby incorporated by reference in its entirety.

### BACKGROUND

1. Field

This disclosure generally relates to the field of computing. More particularly, the disclosure relates to an input system that may be utilized with a computing device.

2. General Background

Currently, one of the most common input devices utilized for inputting information into a computing device is a computer mouse. Traditional forms of the computer mouse involve a device that is moved over a surface, a touch pad, a touch screen, a trackball, etc. These traditional forms of the computer mouse all tend to constrain the hand movements of the user to a small surface and involve the user placing pressure on one or more actuators, e.g., buttons, to perform actions. The constraint and finger pressure endured over a long duration may lead to discomfort and possibly injury as muscle tension may build throughout the hand, arm, shoulder, and/or neck areas. These traditional forms are also inefficient as the user has to move his or hand away from a keyboard to utilize the computer mouse, move the computer mouse, and then place the hand back on to the keyboard. Accordingly, the user may become inefficient with these traditional forms of the computer mouse.

Although some input devices have been developed that track aerial motion of the particular input device, these input devices typically have buttons on the device itself to perform an action such as a click or double click to execute a program. However, once the user positions a mouse pointer over an object and clicks, the mouse pointer may move before the object is clicked. Accordingly, the user may have to make several attempts to perform an action. As a result, users typically experience a loss of accuracy and a sense of difficulty in the operation of such devices.

### SUMMARY

In one aspect of the disclosure, a single wrist user input system is provided. The single wrist user input system includes a wrist band that conforms to a single wrist of a user. Further, the single wrist user input system includes a motion tracking sensor that tracks aerial motion of the single wrist of the user as aerial motion data. The motion tracking sensor is adhered to the wrist band. The aerial motion of the single wrist of the user is performed by the user to move an indicator displayed by a display screen operably connected to a computing device. The motion tracking sensor includes a motion transmitter that transmits the aerial motion data. In addition, the single wrist user input system includes a rotational sensor that tracks rotational movement of the single wrist of the user as rotational movement data. The rotational sensor is adhered to the wrist band. The rotational movement of the single wrist of the user is performed by the user to select, with a predetermined rotational orientation, an object over which the indicator is positioned as displayed by the display screen. The rotational sensor includes a rotational transmitter that transmits the rotational data. The single wrist user input system also includes a receiver that receives the aerial motion data and the rotational movement data to provide the aerial motion data and the rotational movement data to the computing device to (i) display motion of the indicator in the display that corresponds to a filtered motion of the single wrist of the user that excludes a portion of the aerial motion data that coincides with a portion of the rotational movement data that indicates rotational movement of the single wrist of the user towards the predetermined rotational orientation and (ii) select the object based upon the indicator being positioned over the object and the rotational data indicating the predetermined rotational orientation.

In another aspect of the disclosure, a process is provided. The process tracks, with a motion tracking sensor, aerial motion of a single wrist of the user as aerial motion data. The motion tracking sensor is adhered to a wrist band that conforms to a single wrist of a user. The aerial motion of the single wrist of the user is performed by the user to move an indicator displayed by a display screen operably connected to a computing device. The motion tracking sensor includes a motion transmitter that transmits the aerial motion data. Further, the process tracks, with a rotational sensor, rotational movement of the single wrist of the user as rotational movement data. The rotational sensor is adhered to the wrist band. The rotational movement of the single wrist of the user is performed by the user to select, with a predetermined rotational orientation, an object over which the indicator is positioned as displayed by the display screen. The rotational sensor includes a rotational transmitter that transmits the rotational data. Further, the process receives, with a receiver, the aerial motion data and the rotational data. In addition, the process provides the aerial motion data and the rotational data to the computing device to (i) display motion of the indicator in the display that corresponds to a filtered motion of the single wrist of the user that excludes a portion of the aerial motion data that coincides with a portion of the rotational movement data that indicates rotational movement of the single wrist of the user towards the predetermined rotational orientation and (ii) select the object based upon the indicator being positioned over the object and the rotational data indicating the predetermined rotational orientation.

In yet another aspect of the disclosure, a single wrist user input system is provided. The single wrist user input system includes a motion tracking sensor that tracks motion of a single wrist of a user as motion data. The motion tracking sensor is adhered to the single wrist of the user. The motion of the first wrist of the user is performed by the user to move an indicator displayed by a display screen operably connected to a computing device. The single wrist user input system includes a rotational sensor that tracks rotational movement of the single wrist of the user as rotational movement data. The rotational sensor is adhered to the single wrist of the user. The rotational movement of the single wrist of the user is performed by the user to select, with a predetermined rotational orientation, an object over which the indicator is positioned as displayed by the display screen. The single wrist user input system includes a receiver that receives the motion data from the motion tracking device and the rotational data from the rotational sensor, the receiver providing the motion data and the rotational data to the computing device to (i) display motion of the indicator in the display that corresponds to a filtered motion of the single wrist of the user that excludes a portion of the aerial motion data that coincides with a portion of the rotational movement data that indicates rotational movement of the single wrist of the user towards the predetermined rotational orientation and (ii) select the object based upon the indicator being positioned over the object and the rotational data indicating the predetermined rotational orientation.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a two wrist user input configuration.

FIG. 2 illustrates the two wrist user input configuration illustrated in FIG. 1 positioned on to the wrists of a user.

FIGS. 3A-3N illustrate a variety of actions that may be performed by the two wrist input system.

FIG. 3A illustrates an interactive system.

FIG. 3B illustrates the interactive system in which the user makes an upward motion of the first wrist.

FIG. 3C illustrates the interactive system in which the user makes a leftward motion of the first wrist after the upward motion of the first wrist in FIG. 3B to position the pointer over the Internet icon.

FIG. 3D illustrates the interactive system 300 in which the user rotates the second wrist in a predetermined rotational orientation to perform a selection of an object.

FIG. 3E illustrates the interactive system in which the user moves the selected object illustrated in FIG. 3D.

FIG. 3F illustrates the interactive system in which the user executes a computer program associated with the selected object illustrated in FIG. 3D.

FIG. 3G illustrates the interactive system in which the user utilizes the two wrist user input system for word processing.

FIG. 3H illustrates the interactive system in which the user utilizes the two wrist user input system to edit text in the word processing window of FIG. 3G.

FIG. 3I illustrates the interactive system in which the user utilizes the two wrist user input system to edit text in the word processing window of FIG. 3H.

FIG. 3J illustrates the interactive system in which the user utilizes the two wrist user input system to edit text in the word processing window of FIG. 3I.

FIG. 3K illustrates the interactive system in which the user utilizes the two wrist user input system to edit text in the word processing window of FIG. 3J.

FIG. 3L illustrates the interactive system in which the user utilizes the two wrist user input system to edit text in the word processing window of FIG. 3K.

FIG. 3M illustrates the interactive system in which the user utilizes the two wrist user input system to scroll through a window.

FIG. 3N illustrates the interactive system in which the user utilizes the two wrist user input system to scroll through a window of FIG. 3M.

FIG. 4A illustrates a block diagram of a configuration for the two wrist input system.

FIG. 4B illustrates a block diagram that is an alternative configuration for the two wrist input system to the configuration illustrated in FIG. 4A.

FIG. 5 illustrates a process that may be utilized to provide user input.

FIG. 6 illustrates the interactive system of FIG. 3 with a keyboard.

FIG. 7A illustrates the block diagram illustrated in FIG. 4A with the keyboard in direct communication with the computing device.

FIG. 7B illustrates the block diagram illustrated in FIG. 4A with the keyboard in communication with the receiver.

FIG. 8A illustrates a one user input configuration 800.

FIG. 8B illustrates the single wrist user input configuration 800 in which the aerial motion tracking sensor 106 may send aerial motion data to the receiver 110, but may only do so after if rotational movement data that the aerial motion tracking sensor receives and/or does not receive indicates that the aerial motion data for a given time period may be sent.

FIG. 8C illustrates the single wrist user input configuration 800 in which the single data stream may be sent by the rotational sensor 108, which may receive the aerial motion tracking data from the motion tracking sensor 106 and filter aerial motion data to the receiver 110 for the aerial motion data for a given time period if the rotational data indicates and/or does not indicate one more predetermined rotational positions.

FIG. 8D illustrates the single wrist user input configuration in which the single data stream may be sent by a data filter.

FIG. 9 illustrates the one wrist user input configuration positioned on a wrist of the user.

FIGS. 10A-10M illustrate a variety of actions that may be performed by the single wrist user input configuration.

FIG. 10A illustrates an interactive system.

FIG. 10B illustrates a motion of the first wrist to position the pointer over the Internet icon.

FIG. 10C illustrates the first wrist being in palm up position to make the selection of the Internet icon.

FIG. 10D illustrates the movement of the icon based on a movement of the first wrist in the palm up position.

FIG. 10E illustrates the interactive system in which the user executes a computer program associated with the selected object illustrated in FIG. 10C.

FIG. 10F illustrates the interactive system in which the user utilizes the single wrist user input configuration for word processing.

FIG. 10G illustrates the interactive system in which the user utilizes the single wrist user input system to edit text in the word processing window of FIG. 10F.

FIG. 10H illustrates the interactive system in which the user utilizes the single wrist user input system to edit text in the word processing window of FIG. 10G.

FIG. 10I illustrates the interactive system in which the user utilizes the single wrist user input system to edit text in the word processing window of FIG. 10H.

FIG. 10J illustrates the interactive system in which the user utilizes the single wrist user input system to edit text in the word processing window of FIG. 10I.

FIG. 10K illustrates the interactive system in which the user utilizes the single wrist user input system to edit text in the word processing window 314 of FIG. 3K.

FIG. 10L illustrates the interactive system in which the user utilizes the single wrist user input system to scroll through a window.

FIG. 10M illustrates the interactive system in which the user utilizes the single wrist user input system to scroll through a window of FIG. 3M.

FIG. 11 illustrates a process that may be utilized to provide user input.

### DETAILED DESCRIPTION

An apparatus and method are disclosed for a two wrist user input system. The two wrist user input system may be utilized to provide data to a computing device instead of a traditional input system such as a mouse, trackball, touch pad, touch screen, etc. The term computing device is intended herein to include any type of device that has a processor such as a personal computer, desktop computer, laptop, notebook, cell phone, smart phone, personal digital assistant (“PDA”), personal media player, set top box, or the like. By utilizing natural movements of the hands rather than pressing an input device with one or more fingers, the two wrist user input system reduces the physical stress on the various joints of the fingers, hand, arm, shoulder, and neck. As a result, a user may increase the efficiency of providing input to a computing device. Further, the user may decrease the possibility of injury. The enjoyability of the overall user input experience may be enhanced.

In contrast with a traditional input device that requires one hand to apply pressure with one or more fingers to move a pointer and execute computer code associated with objects in a computer display, the two wrist user input system removes the need for such finger pressure by dedicating a first set of functionality to one wrist and a second set of functionality to the other wrist. As an example, a traditional computer mouse may involve a user placing the right hand on top of the computer mouse, moving the right hand in a motion with the mouse to move a pointer in a display, and pressing a left mouse button twice with the right index finger to double click the left mouse button to execute code associated with an icon after the pointer is positioned over the icon. The pressure of the double clicking with the left index finger numerous times and the muscle tension created by keeping the arm in a fixed position for a long period of time can be uncomfortable and lead to injury along with a loss in productivity. In contrast, as an example, the two wrist user input system allows the user to dedicate a first wrist such as the right wrist for motion of the pointer and a second wrist such as the left wrist for actions to be taken. For instance, the user may move the right hand to indicate that the pointer should move in the direction of the right hand. Once the right hand is positioned over an icon, the user may run a program associated with the icon by double palming with the left hand. The term double palming is intended to mean that the user, which will typically have the left hand in a palm down position to type, relax, etc., turns the left hand in a palm up position twice to run the program. Double palming is just an example as a single palm up movement or a different hand position may be configured to run the program. By allowing for natural hand movements of the wrists to provide input to the computing device, the two wrist input system removes the uncomfortable constraints provided by the traditional computer mouse system.

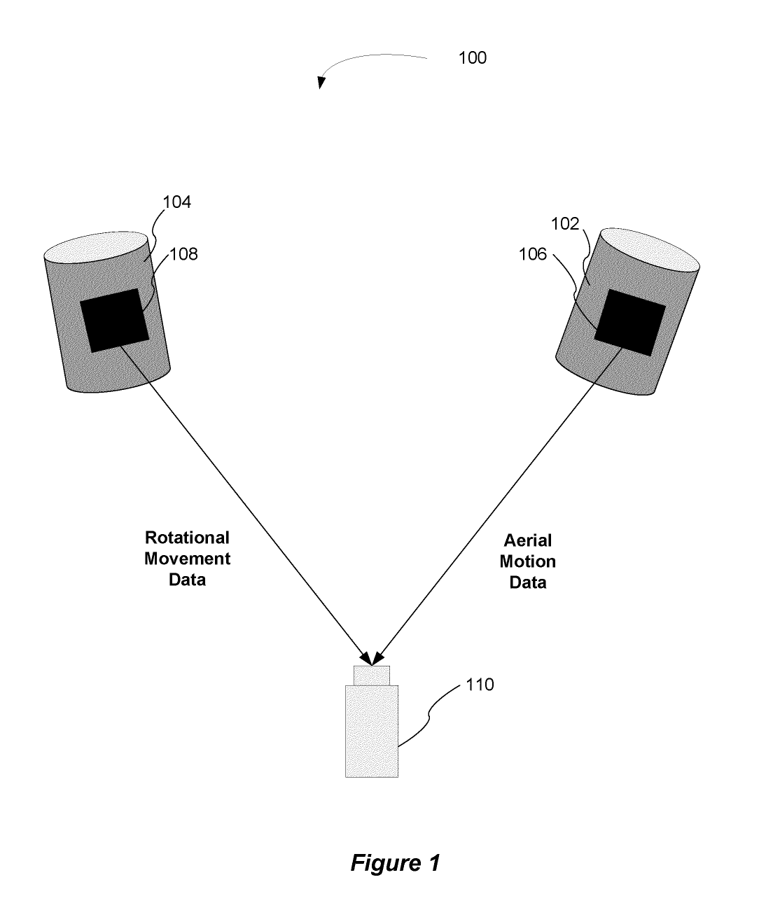

FIG. 1 illustrates a two wrist user input configuration 100. In one embodiment, the two wrist user input configuration 100 includes a first wrist band 102 and a second wrist band 104. The first wrist band 102 has attached thereto a motion tracking sensor 106, which sends aerial motion data to a receiver 110. In one embodiment, the motion tracking sensor 106 is wireless and may send the aerial motion data to the receiver 110 through a wireless communication such as Radio Frequency (“RF”), Infrared (“IR”), or the like. In another embodiment, the motion tracking sensor 106 is a wired device that may send the aerial motion data through a cable, cord, or the like to the receiver 110. The data communication between the motion tracking sensor 106 and the receiver 110 may be a local communication. In another embodiment, the data communication between the motion tracking sensor 106 and the receiver 110 may be a communication through a network. Further, the second wrist band 104 has attached thereto a rotational sensor 108, which sends rotational movement data to the receiver 110. In one embodiment, the rotational sensor 108 is wireless and may send the rotational movement data to the receiver 110 through a wireless communication such as RF, IR, or the like. In another embodiment, the rotational sensor 108 is a wired device that may send the rotational movement data through a cable, cord, or the like to the receiver 110. The data communication between the rotational sensor 108 and the receiver 110 may be a local communication. In another embodiment, the data communication between the rotational sensor 108 and the receiver 110 may be a communication through a network.

The receiver 110 may have the capability to receive wireless communications, hardwired communications, or both. Further, the receiver 110 may be configured to be operably connected to a computing device. As an example, the receiver may have a USB connector, a Serial connector, a Parallel connector, or the like. Alternatively, the receiver 110 may be built into the computing device.

In an alternative embodiment, two receivers may be utilized in place of the receiver 110. For example, a first receiver that receives the aerial motion data may be operably connected to a computing device and a second receiver that receives the rotational movement data may be operably connected to the computing device.

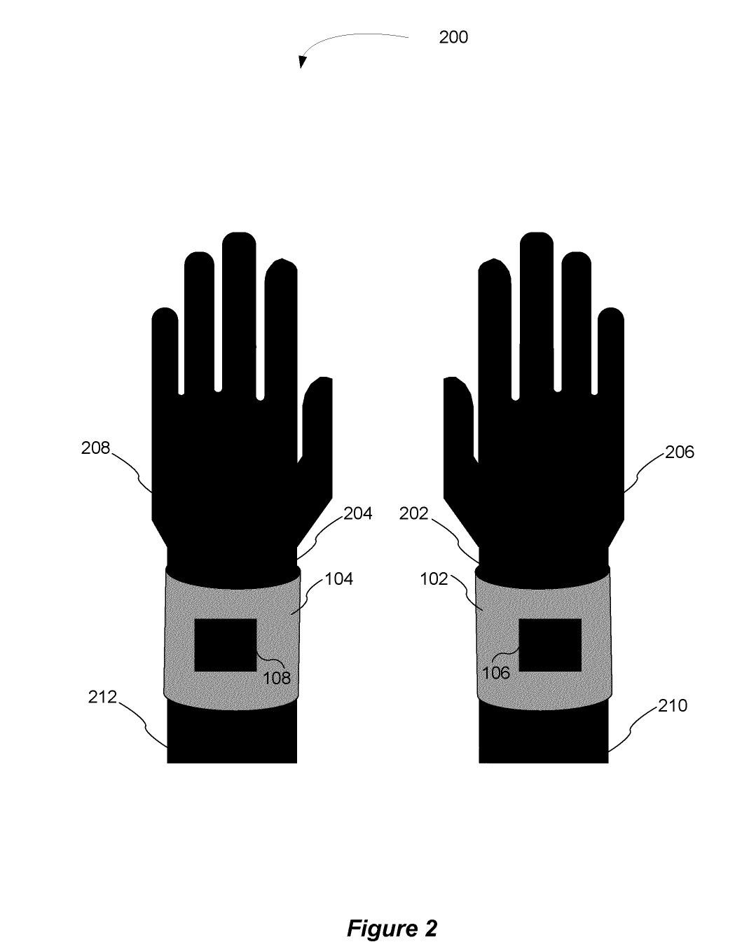

FIG. 2 illustrates the two wrist user input configuration 100 illustrated in FIG. 1 positioned on to the wrists of a user. The first wrist band 102 conforms to a first wrist 202 of a user. The term first wrist 202 is intended to include the portion of the arm of the user that extends from a first forearm 210 of the user to a first hand 206 of the user. In other words, the first wrist band 102 may be positioned over the wrist joint, above the wrist joint by the first hand 206, beneath the wrist joint by the first forearm 210. In another embodiment, the first wrist band 102 may be positioned on other parts of an arm of the user. The term arm is intended to include the limb from the shoulder joint down to the finger tips. For example, the first wrist band 102 may be positioned over the upper part of the first forearm 210 that is proximate to the elbow joint, the upper arm between the elbow joint and the should joint, on the elbow joint, on the first hand 206, on one more fingers of the first hand 206, or the like.

The first wrist band 102 may adhered to the first wrist 202 of the user with a connection mechanism such as a strap, a hook, or any other connection mechanism known to one of ordinary skill in the art. Alternatively, the first wrist band 102 may slide on to the first wrist 202 of the user. In one embodiment, the first wrist band 102 may be made of an elastic material. In one embodiment, the motion tracking sensor 106 is adhered to the first wrist band 102 such that when the user positions the first wrist band on his or her first wrist 202, the motion tracking sensor 106 is situated on top of the first wrist 202 when the first wrist 202 is in a palm down position. With the motion tracking sensor 106 positioned on the top of the first wrist band 106, the user may perform other tasks, e.g., typing, writing, etc., comfortably as the bottom of the first wrist 102 would likely engage a surface such as a desk to perform those other tasks. The motion tracking sensor 106 may be adhered to the first wrist band 102 by any adhering mechanism or methodology known to one of ordinary skill in the art. The term adhere is intended for any of the configurations described herein to mean adhered to the external surface or internal surface an item. As an example, the first wrist band 102 may have a holder to hold the motion tracking sensor 106.

In yet another embodiment, a different type of holding mechanism may be utilized for the motion tracking sensor 106. For example, a glove, clothing, etc. may be utilized in place of the first wrist band 102. The motion tracking sensor 106 may be adhered to a ring. For example, the motion tracking sensor 106 may be attached to a ring or may be built into the ring itself.

In another embodiment, the motion tracking sensor 106 does not have to be adhered to the first wrist band 102 or any other holding mechanism. For example, the motion tracking sensor 106 may have a clip that adheres to a watch, bracelet, or the like. Alternatively, a clip that is separate from the motion tracking sensor 106 may be utilized to adhere the motion tracking sensor 106 to the watch, jewelry, or the like. Alternatively, the motion tracking sensor 106 may simply be held in the first hand 206 of the user without being adhered to the user.

The second wrist band 102 conforms to a first wrist 204 of a user. The term second wrist 204 is intended to include the portion of the arm of the user that extends from a second forearm 212 of the user to a second hand 208 of the user. In other words, the second wrist band 104 may be positioned over the wrist joint, above the wrist joint by the second hand 208, beneath the wrist joint by the second forearm 212. In another embodiment, the second wrist band 104 may be positioned on other parts of an arm of the user. For example, the first second band 104 may be positioned over the upper part of the second forearm 212 that is proximate to the elbow joint, the upper arm between the elbow joint and the should joint, on the elbow joint, on the second hand 208, on one more fingers of the first hand 208, or the like.

The second wrist band 104 may adhered to the second wrist 204 of the user with a connection mechanism such as a strap, a hook, or any other connection mechanism known to one of ordinary skill in the art. Alternatively, the second wrist band 204 may slide on to the second wrist 204 of the user. In one embodiment, the second wrist band 104 may be made of an elastic material. In one embodiment, the rotational sensor is adhered to the second wrist band 104 such that when the user positions the second wrist band 104 on his or her second wrist 204, the rotational sensor 108 is situated on top of the second wrist 204 when the second wrist 204 is in a palm down position. With the motion tracking sensor 106 positioned on the top of the first wrist band 102, the user may perform other tasks, e.g., typing, writing, etc., comfortably as the bottom of the second wrist 204 would likely engage a surface such as a desk to perform those other tasks. The rotational sensor 108 may be adhered to the second wrist band 104 by any adhering mechanism or methodology known to one of ordinary skill in the art. The term adhere is intended for any of the configurations described herein to mean adhered to the external surface or internal surface an item. As an example, the second wrist band 104 may have a holder to hold the rotational sensor 108.

In yet another embodiment, a different type of holding mechanism may be utilized for the rotational device 108. For example, a glove, clothing, etc. may be utilized in place of the second wrist band 108. The rotational sensor 108 may be adhered to a ring. For example, the rotational sensor 108 may be attached to a ring or may be built into the ring itself.

In another embodiment, the rotational sensor 108 does not have to be adhered to second wrist band 104 or any other holding mechanism. For example, the rotational sensor 108 may have a clip that adheres to a watch, bracelet, or the like. Alternatively, a clip that is separate from the rotational sensor 108 may be utilized to adhere the rotational sensor 108 to the watch, jewelry, or the like. Alternatively, the rotational sensor 108 may simply be held in the second hand 208 of the user without being adhered to the user.

Although the sensors are illustrated as being positioned on top of the wrist bands for comfortability, the sensors may be placed on the sides, bottoms, or any other portion of the wrist bands. The predetermined rotational orientations for the second wrist band 104 may change as a result of such different positioning, but the user can then adapt the predetermined rotational orientations to conform with the different positioning of the rotational sensor 108. Although both sensors are shown as being on top of the wrist bands, both sensors do not have to be in the same position. As an example, the rotational sensor 108 may be positioned on top of the second wrist band 104 when the second hand 208 is in a palm down position and the motion tracking sensor 106 may be on the bottom of the first wrist band 102 when the first hand 206 is in a palm down position.

The motion tracking sensor 106 tracks aerial motion of the first wrist 202 of the user as aerial motion data. As an example, the user may move the right hand in the air in a motion that the user would like the pointer to move. For instance, the pointer may be in the bottom right corner of the display screen, and the user may move the right hand in a diagonal motion in the air towards the upper left corner of the screen. The user does not have to touch the display screen when making the motion, but the user may do so if that is the preference of the user.

In one embodiment, the aerial motion data is measured with the vertical axis of the measured aerial motion data being parallel with the vertical axis of the display screen. For example, if the user moves the motion tracking device 106 in an upward motion along a y-axis parallel with the vertical axis of the display screen, the motion is translated into the coordinate space of the display screen to move the pointer in an upward motion on the display screen. Further, in this configuration, the aerial motion data may be measured with the horizontal axis of the measured aerial motion data being parallel with the horizontal axis of the display screen. For example, if the user moves the motion tracking device 106 in a motion to the right along an x-axis parallel with the horizontal axis of the display screen, the motion is translated into the coordinate space of the display screen to move the pointer in an motion to the right on the display screen. In addition, in this configuration, the aerial motion data may be measured with the z-axis of the measured aerial motion data being orthogonal to the display screen. For example, with respect to a two dimensional display screen, if the user moves the first wrist 202 five feet away from the display screen for part of the motion and ten feet away from the display screen for the other part of the motion, that distance from the display screen may not change the motion of the pointer. The up and down motions of the user move the pointer. If the display screen or other display apparatus displays a three dimensional display, the movement along the z-axis is displayed.

In another embodiment, the aerial motion data is measured with the vertical axis of the measured aerial motion data being orthogonal to the display screen. For example, if the user moves the motion tracking device 106 in an upward motion along a y-axis orthogonal to the display screen, i.e., in a motion towards or away from the display screen, the motion is translated into the coordinate space of the display screen to move the pointer in an upward motion on the display screen. Further, in this configuration, the aerial motion data may be measured with the horizontal axis of the measured aerial motion data being parallel with the horizontal axis of the display screen. For example, if the user moves the motion tracking device 106 in a motion to the right along an x-axis parallel with the horizontal axis of the display screen, the motion is translated into the coordinate space of the display screen to move the pointer in an motion to the right on the display screen. In addition, in this configuration, the aerial motion data may be measured with the z-axis of the measured aerial motion data being parallel to the vertical axis of the display screen. For example, with respect to a two dimensional display screen, if the user moves the first wrist 202 one foot from the bottom of the display screen towards the top of the display screen, that motion may not change the motion of the pointer. The forward and backward motions of the user move the pointer. If the display screen or other display apparatus displays a three dimensional display, the movement along the z-axis is displayed.

A variety of different axes may be utilized. In one embodiment, the user may select the axes orientation of preference. One or more actuators on the receiver 110, one of the wrist bands, or one of the sensors may be effectuated to change axes configurations. Alternatively, a computer program may be utilized to change axes.

In one embodiment, the two wrist user input system may be utilized for motion over a surface rather than the air with any of the axes configurations. In yet another embodiment, a three dimensional coordinate system is utilized.

For example, if a display is a three dimensional display, the distance from the display screen, up motion, down motion, right motion, and left motion are factored into the movement of the pointer. In one embodiment, the two wrist user input system may be utilized for both motion in the air and over a surface. Various coordinate systems, planes, transformation, and/or mapping technologies may be utilized to track the motion of the first wrist 202 and display a corresponding motion of an indicator on a display screen. The indicator may be a pointer, cursor, or any other graphical display that may correspond to the motion of the first wrist 202.

The motion tracking sensor 106 may include a motion transmitter that transmits the aerial motion data to the receiver 110. For example, the motion transmitter may be integrated within the motion tracking sensor 106. In one embodiment, the motion transmitter may provide an RF signal, IR signal, or any other type of wireless signal to the receiver 110. In another embodiment, the motion transmitter may provide data through a wire connection to the receiver 110. In one embodiment, the motion tracking sensor 106 sends the aerial motion data without a transmitter to the receiver 110.

In another embodiment, the motion transmitter is separate from the motion tracking sensor 106. For example, the motion transmitter may be separately adhered to the first wrist band 102 and be operably connected to the motion tracking sensor 106.

In yet another embodiment, a motion transceiver is utilized in place of the motion transmitter. Accordingly, the motion transceiver may receive data from the computing device. For example, if a transceiver is utilized in place of the receiver 110, then a motion transceiver may also be utilized in place of the motion transmitter so that the motion transceiver may send and receive data from the transceiver.

In another embodiment, the motion tracking sensor 106 has a processor that processes the aerial motion data prior to sending the aerial motion data to the computing device. In an alternative embodiment, the motion tracking sensor does not process the aerial motion data prior to sending the aerial motion data to the computing device as the computer device process the aerial motion data.

The motion tracking sensor 106 may include one or more measurement components to track the aerial motion of the first wrist 202. For example, the motion tracking sensor 106 may include one or more accelerometers to measure the aerial motion data. For instance, the acceleration of the motion tracking sensor 106 along one or more axes may be measured. Further, the motion tracking sensor may include one or more gyroscopes to measure the aerial motion data. For instance, the rotation of the motion tracking sensor 106 along one or more axes may be measured to obtain roll, pitch, and/or yaw data. In one embodiment, the measuring of this particular rotational movement is for the determination of motion of the first wrist 202, not for the purpose of a predetermined rotational orientation as is measured for the second wrist 204. In addition, the motion tracking sensor may include one or more accelerometers and/or one or more gyroscopes. Such technology allows for the determination of aerial motion of the first wrist 202 so that the aerial motion may be translated into a coordinate system of the display. Any other technology known to one skilled in the art for the determination of aerial motion of the first wrist 202 may be utilized.

In one embodiment, vector motion of the first wrist 202 is measured. In other words, the user does not have to have the first wrist 202 directly aligned with the indicator to move the indicator. For example, the user may move the first wrist 202 to the left and a vector in that direction is measured so that the indicator moves to the left. In another embodiment, the user moves the first wrist 202 along a predetermined plane. For example, the user may have to move the first wrist 202 along a certain path to indicate the motion.

The rotational sensor 108 may include one or more measurement components to track the rotational movement of the second wrist 204. The rotational sensor 108 may be an electronic compass, a position sensor, a proximity sensor, a magnetic position sensor, or the like may be utilized. As an example, if an electronic compass is utilized, the rotational sensor 108 may be positioned on the top of the second wrist band 104 such that the electronic compass has a reading of north when the user is typing or relaxing the second wrist 204 in a palm down position. The electronic compass may indicate that the second wrist 204 is in a palm up position when the electronic compass provides a reading of south. The rotational sensor 108 may be configured to provide a reading of north, south, east, or west if the electronic compass is not exactly in such positions. For example, if the user has the position of the second wrist 204 in a position that is within ten degrees of south, the rotational sensor 108 may provide a reading of south. The example of ten degrees is only provided for illustrative purposes as the degrees of freedom configured may be greater or less than this example. The electronic compass may have a magnetic sensor that determines the orientation with respect to north, south, east, or west. In one embodiment, the rotational sensor 108 has a processor that processes the output in view of any degrees of freedom if such degrees of freedom are so configured. The rotational movement is processed to determine if a predetermined rotational orientation such as palm up, palm to the side with thumb up, etc. has been effectuated by the user to request that an action be performed on the display. In another embodiment, the rotational sensor 108 provides the output from the electronic compass to the processor operably connected with the computing device for that processor to process in view of any degrees of freedom if such degrees of freedom are so configured. A sensor other than an electronic compass may be utilized. Any sensor known to one skilled in the art that detects the rotation of the second wrist 204 into and out of predetermined rotational orientations may be utilized.

As another example, the rotational sensor 108 may include one or more accelerometers to measure the rotational movement data. For instance, the acceleration of the rotational sensor 108 along one or more axes may be measured. Further, the motion tracking sensor may include one or more gyroscopes to measure the rotational movement data. For instance, the rotation of the rotational sensor 108 along one or more axes may be measured to obtain roll, pitch, and/or yaw data. In addition, the rotational sensor 108 may include one or more accelerometers and/or one or more gyroscopes. Accordingly, the amount of rotation within a given time period may be calculated to initiate an action. For example, the second wrist 204 may be in a palm down position with the rotational sensor 108 on top of the second wrist 204. When the user rotates to a palm up position, the rotational sensor 108 moves approximately one hundred eighty degrees downward in a short period of time. That one hundred eighty degree downward rotation can be measured with the one or more accelerometers and/or the one or more gyroscopes. Further, one or more degrees of freedom may be configured, e.g., ten degrees to allow for the possibility of the rotation not being in an exact palm up position. Accordingly, an action is indicated to be performed as a result of the palm up position. Further, the palm down position from the palm up position may be sensed by a one hundred eighty degree upward rotation with one or more possible degrees of freedom. In addition, the palm to the side with thumb up position may be sensed by a ninety degree upward rotation from the palm down position with one or more possible degrees of freedom. The palm down position from the palm to the side with thumb up position may be sensed by a ninety degree downward rotation with one or more possible degrees of freedom. Any other technology known to one skilled in the art for the determination of the rotation of the second wrist 204 may be utilized.

The user indicates the rotational movement when the indicator is positioned over an object in the display screen as the user would like to perform an action on the object. The user may wish to move the object, explore the contents of the object, execute a program associated with the object, edit the contents of the object, scroll through the object, etc. In essence, the user moves the indicator with the first wrist 202 to get to the object and rotates second wrist 204 according to a predetermined rotational orientation to perform an action on the object.

The rotational sensor 108 may include a rotational transmitter that transmits the rotational movement data to the receiver 110. For example, the rotational transmitter may be integrated within the rotational sensor 108. In one embodiment, the rotational transmitter may provide an RF signal, an IR signal, or any other type of wireless signal to the receiver 110. In another embodiment, the rotational transmitter may provide data through a wire connection to the receiver 110. In one embodiment, the rotational sensor 108 sends the rotational movement data without a transmitter to the receiver 110.

In another embodiment, the rotational transmitter is separate from the rotational sensor 108. For example, the rotational sensor 108 may be separately adhered to the second wrist band 104 and be operably connected to the rotational sensor 108.

In yet another embodiment, a rotational transceiver is utilized in place of the rotational transmitter. Accordingly, the motion transceiver may receive data from the computing device. For example, if a transceiver is utilized in place of the receiver 110, then a rotational transceiver may also be utilized in place of the rotational transmitter so that the rotational transceiver may send and receive data from the transceiver. In yet another embodiment, the receiver 110 is not utilized as the motion tracking sensor 106 may provide the aerial motion data directly to the computing device and the rotational sensor 108 may provide the aerial motion data directly to the computing device.

Although the term aerial motion is utilized, the motion may be performed according to any of the measured axes in the air or on a surface. In other words, motion data is measured irrespective of where the location of the sensors.

For illustrative purposes, the first hand 206 is illustrated as the right hand and the second hand is illustrated as the left hand 208 of the user. The hand motions and predetermined rotational orientations described herein are in the context of that example. However, a user may choose to place the motion sensor device 106 on the left hand and the rotational sensor 108 on the right hand. Accordingly, the hand motions and predetermined rotational orientations described herein would be modified to accommodate such a user choice.

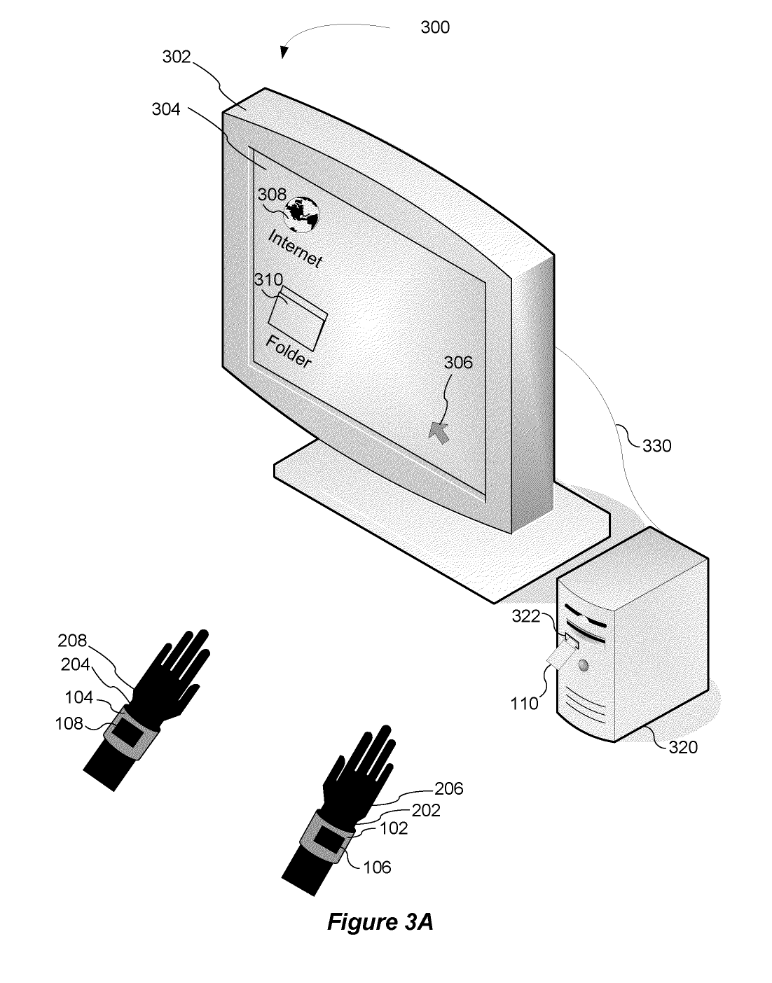

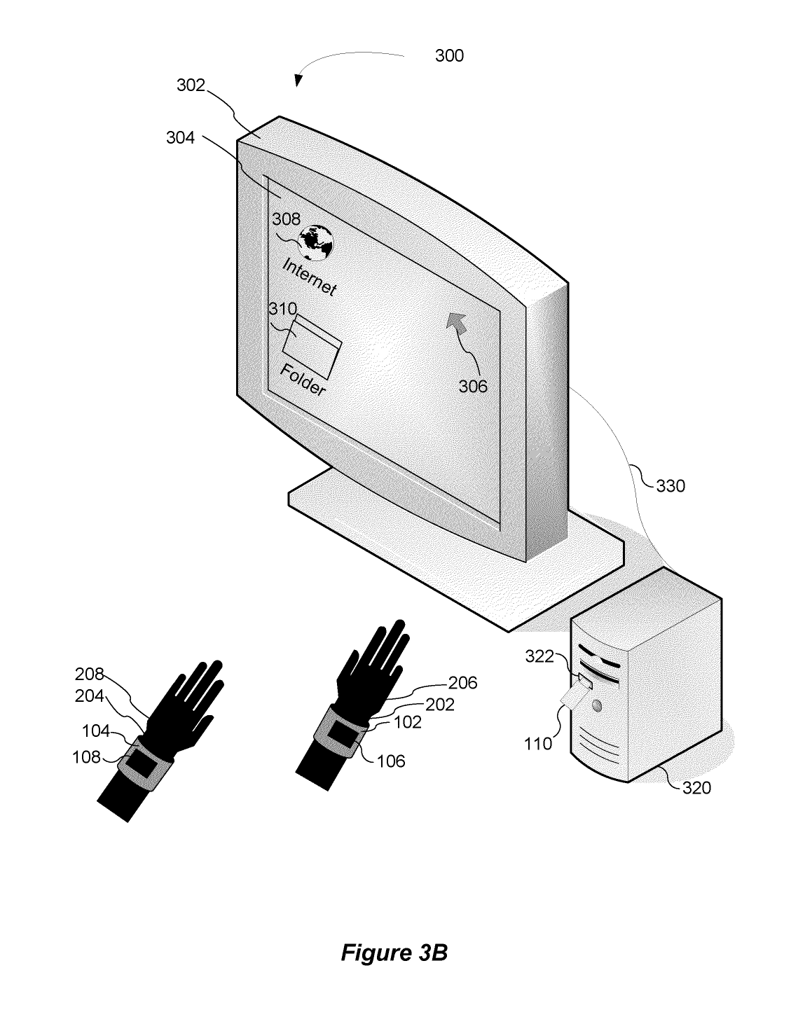

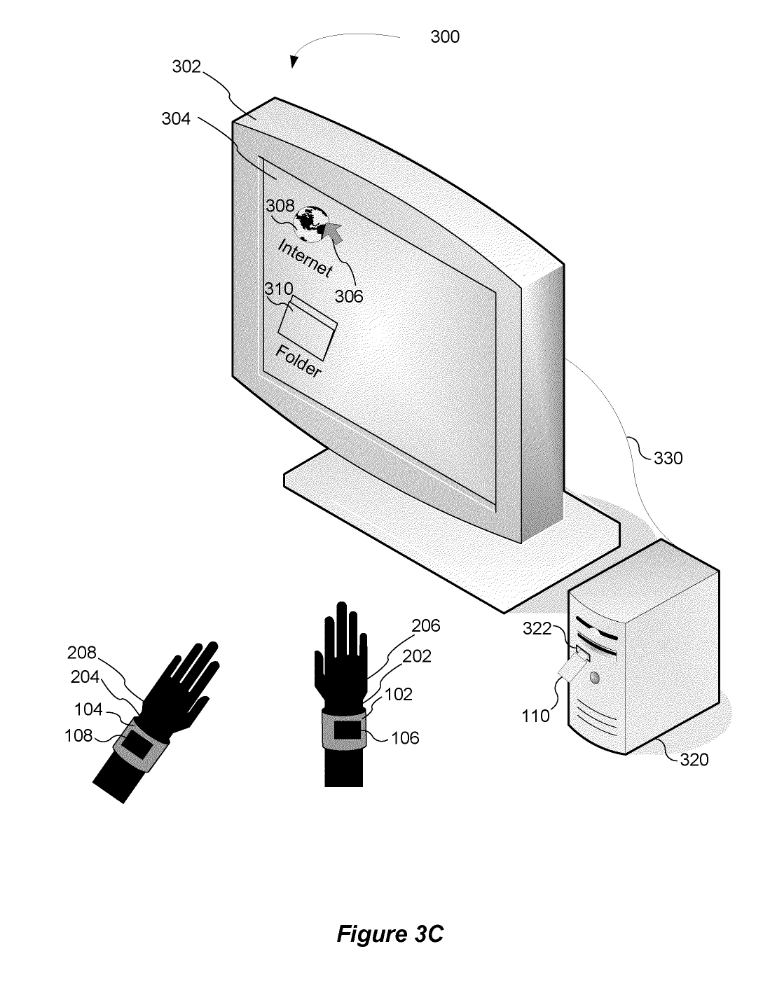

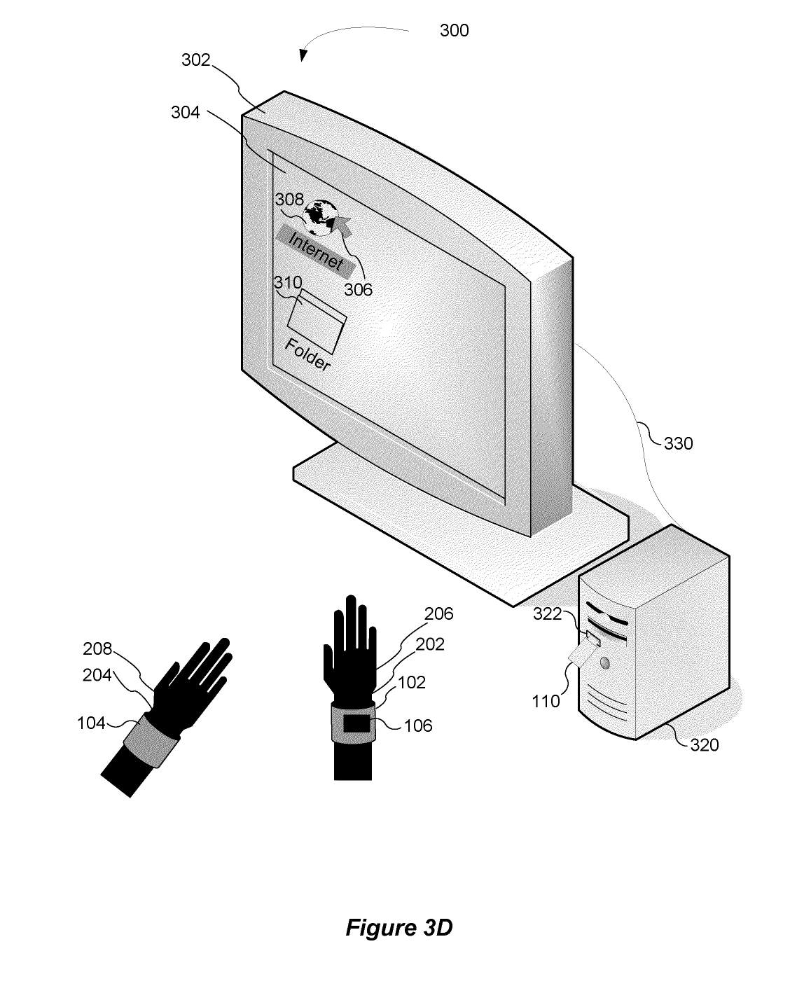

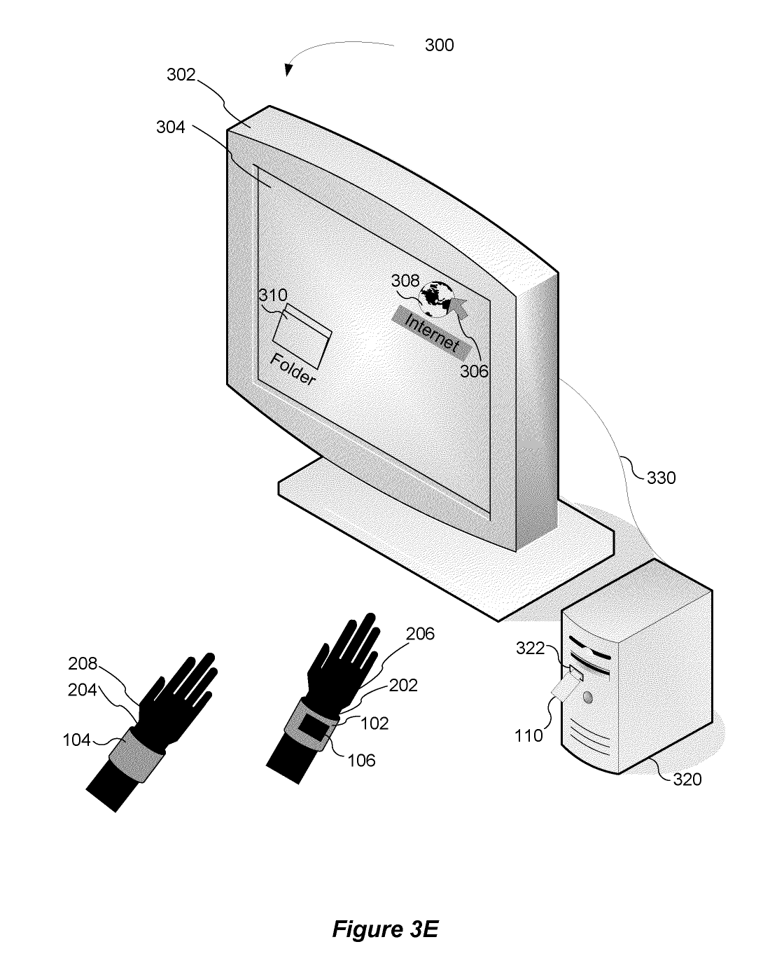

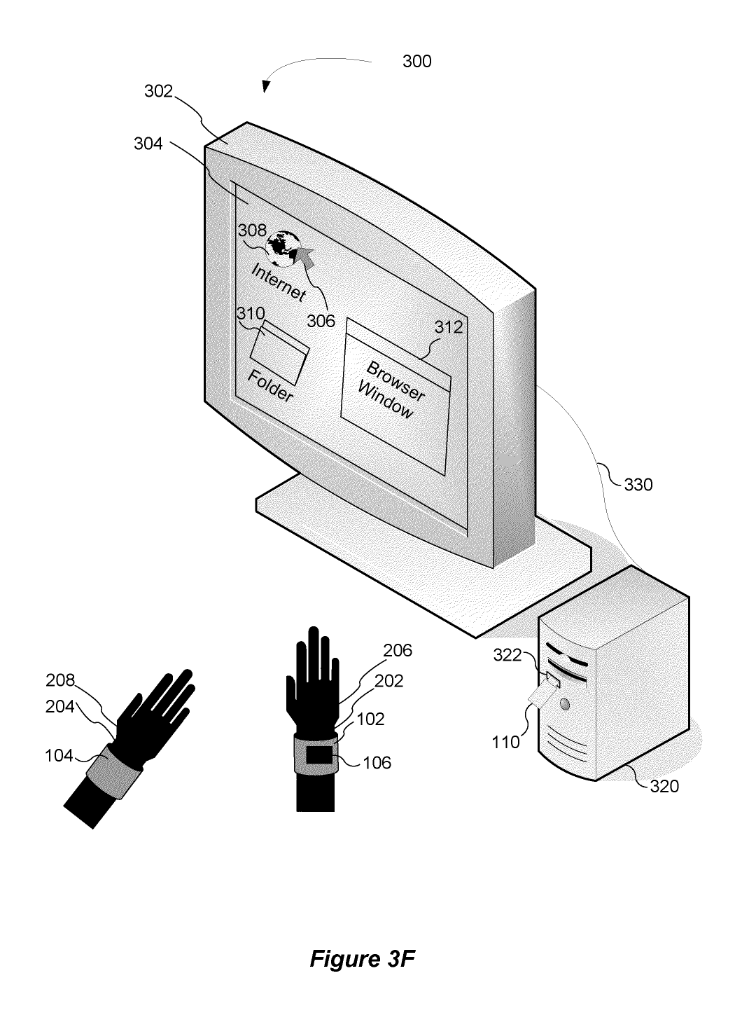

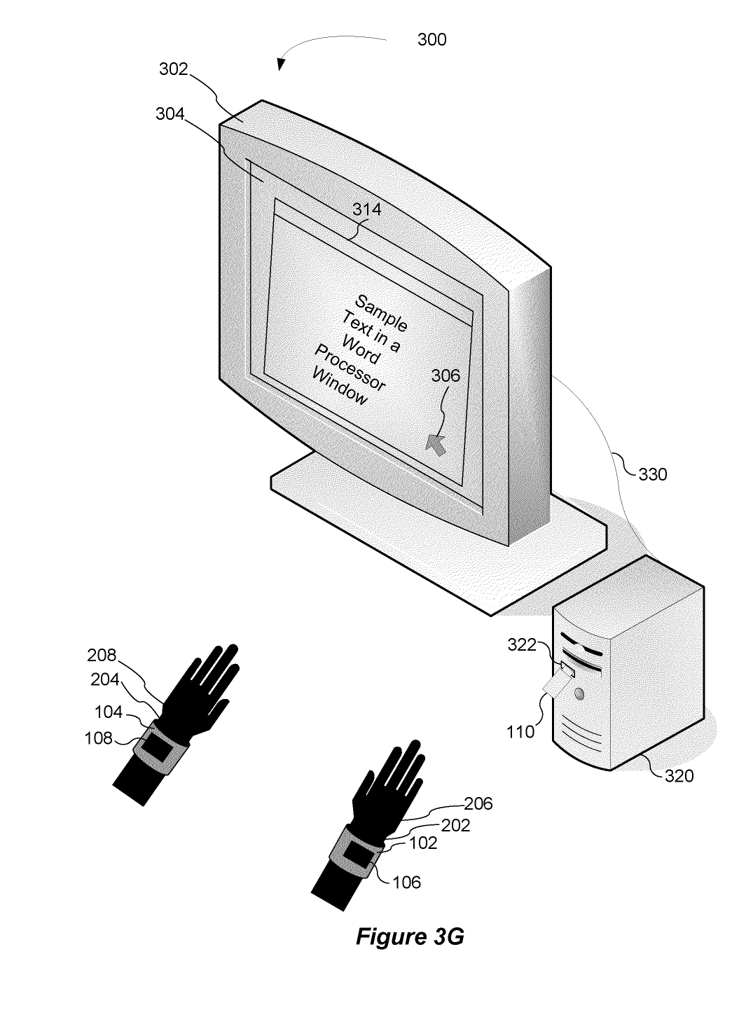

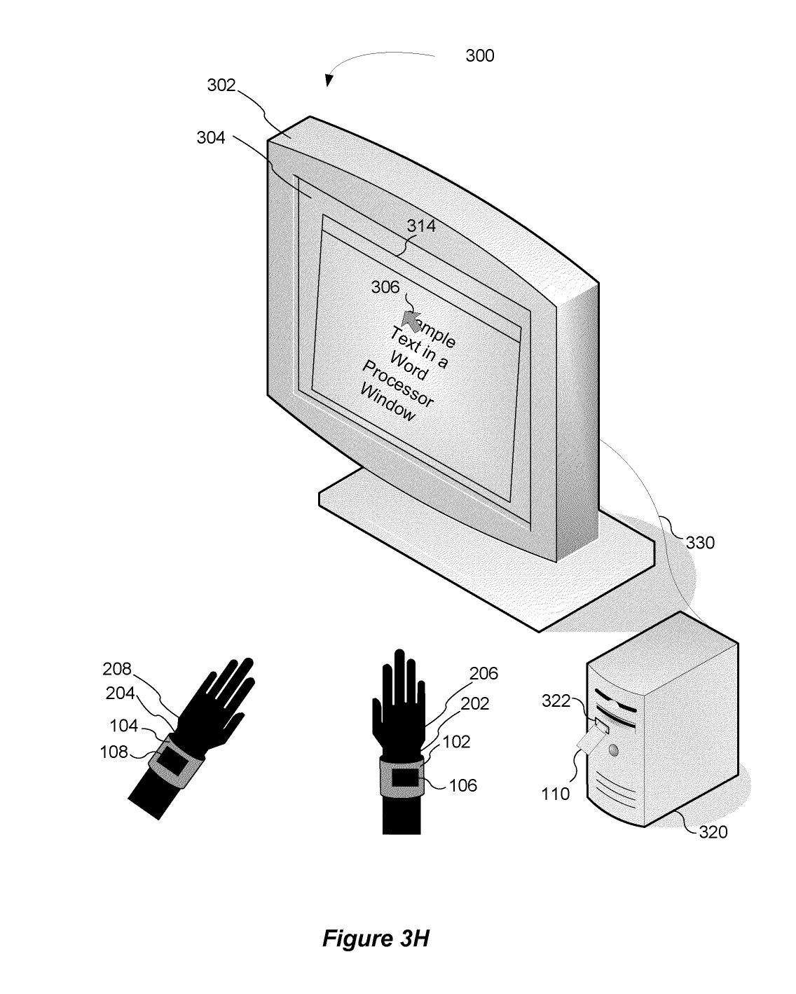

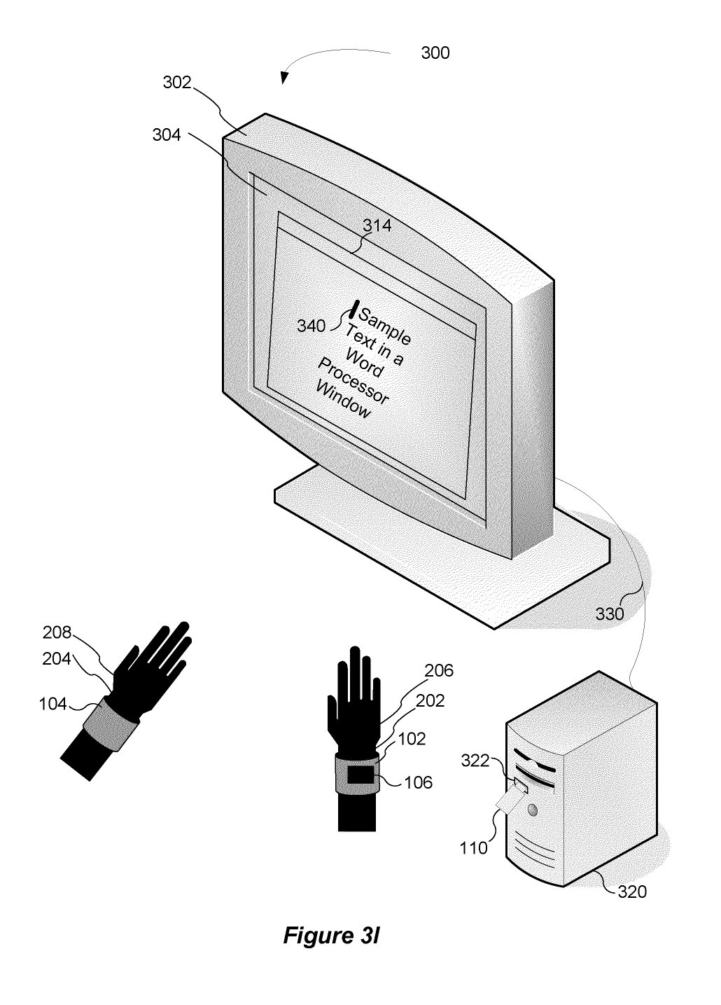

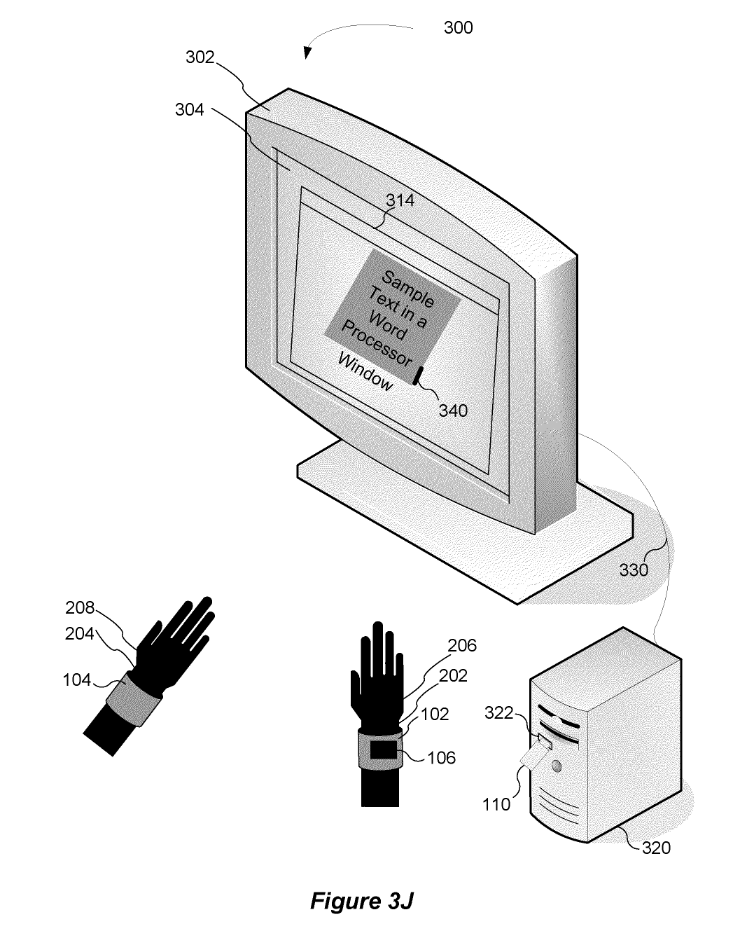

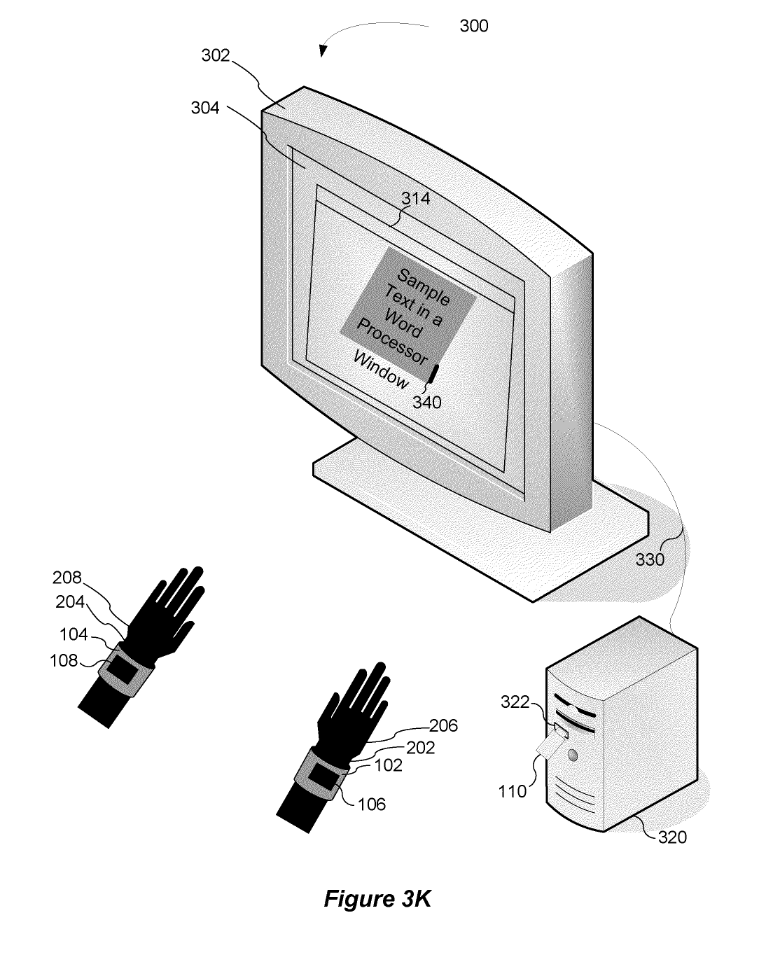

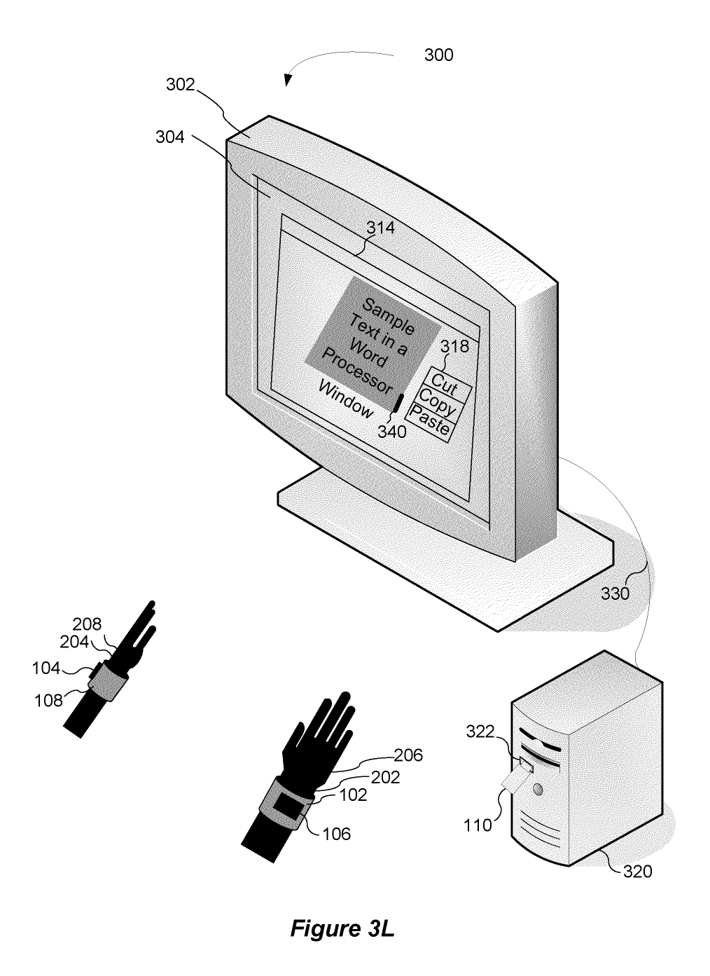

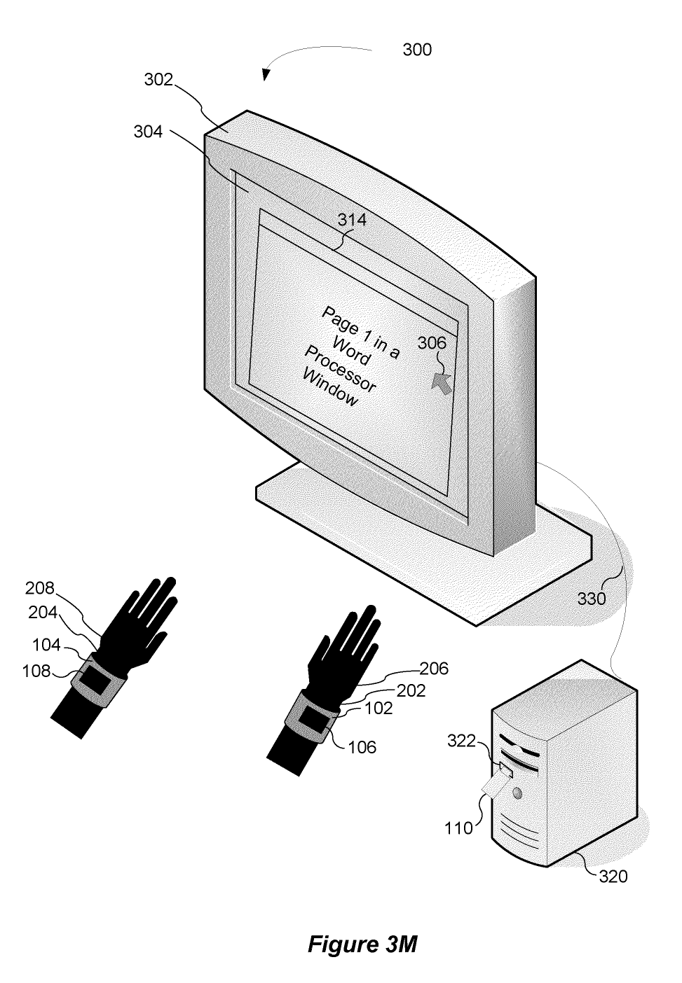

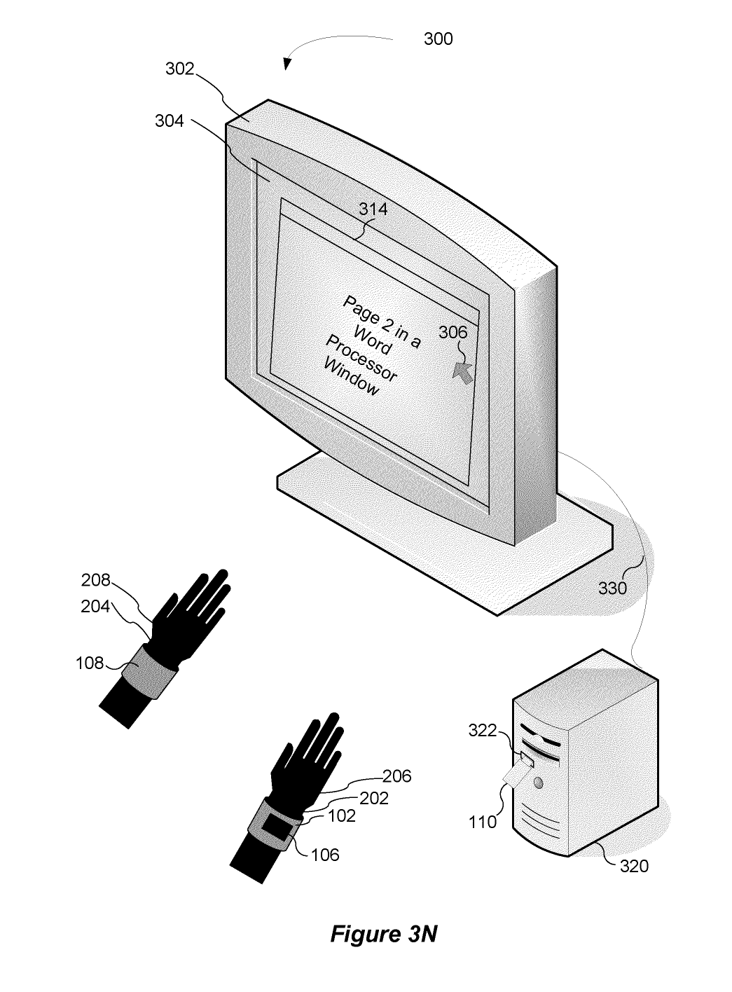

FIGS. 3A-3N illustrate a variety of actions that may be performed by the two wrist user input system. FIG. 3A illustrates an interactive system 300. The interactive system 300 has a display device 302 with a display screen 304. The display device 302 is operably connected to a computing device 320 with a cable 330. In an alternative embodiment, the display device 302 may communicate with the computing device 320 through wireless communication. In yet another alternative embodiment, the display device 302 may be integrated into the computing device 306. Although the illustrated example of the display device 302 is a video monitor, the display device 302 may be a variety of other display devices such as a screen of a laptop, a television screen, a terminal screen, a kiosk screen, a cell phone screen, a smart phone screen, a PDA screen, or the like.

In one embodiment, the receiver 110 may engage a port 322 in the computing device 320. As an example, the receiver 110 may be a USB device and the port 322 may be a USB port. In an alternative embodiment, the receiver 110 may be integrated within the computing device 320. In yet another embodiment, the receiver 110 may engage a port in the display device 302. In an alternative embodiment, the receiver 110 may be integrated within the computing device 320.

The display screen 304 may display one or more objects with which a user may interact. For example, an Internet icon 308 is associated with an Internet program that when executed generates an Internet browser that a user may utilize to browse the Internet. Further, a folder 310 may have contents such as data files. In one embodiment, the folder 310 is associated with computer code that when executed allows the user to explore the contents of the folder 310. A pointer 306 moves throughout the display 306. The movement of the pointer 306 is based on a mapping of the aerial motion of the motion tracking sensor 106, which is adhered to the first wrist band 102 that conforms to the first wrist 202.

FIG. 3B illustrates the interactive system 300 in which the user makes an upward motion of the first wrist 202. As a result of the user making an upward motion of the first wrist 202, the motion tracking sensor 106 makes an upward motion. This illustration is intended to illustrate the user moving the hand 206 upward along a y-axis that is parallel to the y-axis of the display screen 304. Any other upward or downward motions of the pointer 306 in FIGS. 3C-3N are also a result of the user moving the hand 206 upward or downward along a y-axis that is parallel to the y-axis of the display screen 304. However, in an alternative configuration the user may move the hand towards or away the screen in a y-axis that is orthogonal to the display screen 304 to effectuate an upward or downward motion of the pointer 306. The motion tracking sensor 106 tracks the aerial motion data and sends the aerial motion data to the receiver 110, which provides the aerial motion data to the computing device 320. A processor may be operably connected to the computing device 320 to process the aerial motion data. The processor transforms the aerial motion data into motion data specific to the display screen 304 so that the display screen 304 displays upward motion of the pointer 306 corresponding to upward motion of the motion tracking sensor 106. For example, the processor may know the x and y coordinates of the current position of the pointer 306. The processor may then determine in the coordinate system of the display screen 304 either the new intended position of the pointer 306 or vector changes from the current position of the pointer 306 based on the aerial motion data. In one embodiment, the processor may also have to preprocess the aerial motion data to have the aerial motion data in a data format that can be mapped to the display screen 304. In another embodiment, a processor in the aerial motion tracking sensor 106 performs this preprocessing so that the processor operably connected with the computing device 320 only has to perform the mapping for the display screen 304. In yet another embodiment, a transceiver is utilized in place of the receiver 110 so that the transceiver may send data specific to the display 304 such as the coordinate system of the display 304 to the aerial motion tracking sensor 106. A processor in the aerial motion tracking sensor 106 may then map the motion of the aerial motion tracking sensor 106 as specific positions or changes that should be applied to the current position data stored by the processor operably connected to the computing device 320. The processor in the aerial motion tracking sensor 106 may then send these specific positions or changes that should be applied to the current position data to the processor operably connected with the computing device 320. The term operably connected is intended to mean separately connected or integrated within.

FIG. 3C illustrates the interactive system 300 in which the user makes a leftward motion of the first wrist 202 after the upward motion of the first wrist 202 in FIG. 3B to position the pointer 306 over the Internet icon 308. The aerial motion data is determined and processed in a similar manner as that described in FIG. 3B so that the motion of the pointer 306 is displayed as a leftward motion until the pointer 306 is positioned over the Internet icon 308. As the second wrist 204 is illustrated as being in the palm down position, no action is performed. The user could choose to perform an action by moving the second wrist 204 to a predetermined rotational orientation, keep moving the pointer 306 to another location in the display screen 304, or do nothing and leave the mouse pointer in the same position.

FIG. 3D illustrates the interactive system 300 in which the user rotates the second wrist 204 in a predetermined rotational orientation to perform a selection of an object. For example, a predetermined rotational orientation may be a single palm up position when rotational sensor is positioned on top of the second wrist to select an object when the pointer 306 is positioned over the object. Accordingly, after the pointer 306 is positioned over the Internet icon 306, the user turns the second wrist 204 in a palm up position. The receiver 110 receives both the aerial motion data that the pointer 306 is to be positioned in the area over which the Internet icon 306 is positioned and the rotational movement data that the second wrist 204 is in a palm up position. The processor operably connected with the computing device 320 may be configured to know the actions associated with different predetermined rotational orientations. Accordingly, the processor operably connected to the computing device 320 may determine from the rotational movement data that a selection action is to be performed at the current position of the pointer 306. Accordingly, the text of the Internet icon is highlighted. In an alternative embodiment, the icon may be highlighted without the text being highlighted. In yet another alternative embodiment, the icon and the text of the icon may both be highlighted.

In another configuration, the icon, text, or icon and text are highlighted once the pointer 306 is positioned over the object for a predetermined period of time without the second wrist 204 being turn in a palm up position. For example, if the first wrist 202 motions the pointer 306 over the object and keeps the pointer positioned over the object for a predetermined time such as two seconds, the processor may automatically highlight the object. The user may then move the pointer 306 to a different part of the display and turn the second wrist 204 palm up to remove the highlighting from the object.

In yet another alternative configuration, no highlighting is required. The pointer 306 is simply positioned over the icon.

In an alternative embodiment, the rotational sensor 108 may have a processor that is configured to know the actions associated with different predetermined rotational orientations. In this configuration, the rotational sensor 108 may determine that the second wrist is in a palm up position. The rotational sensor 108 may then provide the action to be performed to the processor operably connected to the computing device 320. In other words, the processor operably connected to the computing device 320 may not have to be aware that a rotation occurred and the effect of that rotation. The processor operably connected to the computing device 320 may simply receive a command such as select the object over which the cursor 306 is positioned.

FIG. 3E illustrates the interactive system 300 in which the user moves the selected object illustrated in FIG. 3D. In one embodiment, once the user turns the second wrist 204 in a palm up position, the object remains selected for the duration that the second wrist 204 remains in the palm up position. Accordingly, the user may move the first wrist 202 to move both the pointer 306 and the selected Internet icon 308 over which the pointer 306 is positioned. In FIG. 3E, the user moves the first wrist 202 to the right to drag the Internet icon 308 to the right. Once the user moves the Internet icon 308 to the intended position, the user may turn the second wrist 204 palm down so that the Internet icon 308 is no longer selected and the pointer 306 may move freely without movement of the Internet icon 308.

In the configuration in which the object is already highlighted after the pointer 306 is positioned over the object for a predetermined period of time, the user may keep the pointer 306 positioned over the object and at the same time turn the second wrist 204 palm up. The user may then move the first wrist 202 to the right while the second wrist 204 is in the palm up position to move the object to the right. In the configuration in which the object is not highlighted, the user simply moves the pointer 306 and the object after the pointer 306 is positioned over the object and the second wrist 204 is in a palm up position.

With any of the configurations described with respect to FIG. 3E, the user may provide input to the computing device 320 in a comfortable and accurate manner. The user can comfortably hold the first wrist 202 steady as the fingers of the first hand 206 do not have to perform any type of pressing motion. The first wrist 202 does not have to move downward to click a button at the cost of losing accuracy of the position of the pointer 306 as the second wrist 204 is responsible for the action to be performed on the object.

FIG. 3F illustrates the interactive system 300 in which the user executes a computer program associated with the selected object illustrated in FIG. 3D. In one configuration, the user has turned the second wrist 204 to a palm up position to select the Internet icon 308 once the pointer 306 is positioned over the Internet icon 308. The user may then turn the wrist 204 to a palm down position and then back to a palm up position in a predetermined amount of time to indicate that the Internet browser 312 associated with the Internet icon 308 should be invoked. As a result, a browser window 312 is displayed. As an example, a predetermined time period may be three seconds. In another embodiment, no time restriction is imposed for the double palming. For example, the user may make the first palm up motion to select the Internet icon 308 and make a second palm up motion after turning out of the first palm up motion without a time restriction so long as the Internet icon 308 stays selected. The user may move the pointer 306 elsewhere without making another selection and then move the cursor 306 back over the Internet icon 308 to make the second palm up motion to display the browser window 312. The processor operably connected with the computing device 320 may determine from the rotational movement data that a palm up position of the second wrist 204, a palm down position of the second wrist 204, and a palm up position of the wrist 204 occurred within three seconds. The processor operably connected with the computing device 320 may then determine that the browser window 312 should be displayed. In another embodiment, the user may not have to completely move the second wrist 204 to a palm down position between the palm up positions. An angle in between the palm up an palm down positions may be selected so that the user may perform the double palming more quickly. For example, a threshold such as twenty degrees may be established so that if the user rotates the second wrist 204 more than twenty degrees from the palm up position, the user can then rotate the second wrist 204 back to the palm up position without an intermediary palm down position to effectuate the double palming to display the browser window 312. The threshold of twenty degrees is utilized herein merely as an example as any number of degrees between the palm up position and the palm down position of the second wrist 204 may be utilized.

In the configuration in which the object is already highlighted after the pointer 306 is positioned over the object for a predetermined period of time, the user may keep the pointer 306 positioned over the object and perform a single palm up movement to display the browser window 312. In the configuration in which no highlighting is required, the pointer 306 is simply positioned over the icon with the first wrist 202 and the second wrist 204 makes a single palm up motion to display the browser window 312. Any of these single palming configurations may be utilized to invoke computer code associated with an object.

After double palming or single palming to display the browser window 312, the user may turn the second wrist 204 to the palm down position to allow the pointer 306 to move freely. In any of the configurations provided herein, a degree of freedom may be provided so that the user may allow the pointer 306 to move freely if the wrist 204 is in an approximate, but not exact palm down position. For example, if the second wrist 204 is within fifteen degrees of a palm down position, the user may be able to move the pointer 306 freely.

FIG. 3G illustrates the interactive system 300 in which the user utilizes the two wrist user input system for word processing. The display 304 displays a word processing window 314. The two wrist user input system may be utilized not only to invoke a program such as a word processing program, but also to utilize such a program. The two wrist user input system may be utilized with other software applications such as spreadsheet programs, presentation programs, communication programs, computer aided design programs, or the like.

FIG. 3H illustrates the interactive system 300 in which the user utilizes the two wrist user input system to edit text in the word processing window 314 of FIG. 3G. The user moves the first wrist 202 to move the pointer 306 to the beginning of the text.

FIG. 3I illustrates the interactive system 300 in which the user utilizes the two wrist user input system to edit text in the word processing window 314 of FIG. 3H. The user turns the second wrist 204 to a palm up position to change the pointer 306 into a cursor 340. The user may turn the second wrist 204 out of the palm up position and back into the palm up position since the pointer 306 has already changed into a cursor.

FIG. 3J illustrates the interactive system 300 in which the user utilizes the two wrist user input system to edit text in the word processing window 314 of FIG. 3I. The user may keep the second wrist 204 in the palm up position and move the first wrist to the right and down to highlight some or all of the text.

FIG. 3K illustrates the interactive system 300 in which the user utilizes the two wrist user input system to edit text in the word processing window 314 of FIG. 3J. The user turns the second wrist 204 back into the palm down position to end the highlighting of the text. In one configuration, the second wrist 204 may simply be turned out of the palm up position without having to go all the way back to the palm down position.

FIG. 3L illustrates the interactive system 300 in which the user utilizes the two wrist user input system to edit text in the word processing window 314 of FIG. 3K. In one configuration, after the text has been highlighted, the user has turned the second wrist 204 into a palm down position as seen in FIG. 3K. The user now has a highlighted portion of text that may be edited. In one embodiment, the user may utilize a predetermined rotational orientation to invoke a menu 318 of possible actions that may be performed by the computing device with respect to the selected text. As an example, the user may turn the second wrist 204 into a side palm position such that the thumb is pointing up to invoke the menu 318. As an example, the rotational sensor 104 may have an electronic compass that senses an approximate position of west with a degree of freedom.

The utilization of this predetermined rotational orientation for the menu 318 is not limited to word processing. For example, in FIG. 3D, when the cursor 306 is positioned over the Internet icon 308 and the second wrist 204 is turned into a palm up position to select that icon, the user may turn the second wrist 204 into a palm down position and then into a side palm position with thumb up to invoke a menu of actions to perform on the Internet icon 308. In one embodiment, a time restriction for a predetermined amount of time is imposed for the side palm position with thumb up position after the selection with the palm down position. In another embodiment, no time restriction is imposed.

In one embodiment, the user has to hold the second wrist 204 in the side palm position with thumb up for a predetermined holding threshold to invoke the menu. The predetermined holding threshold is a predetermined amount of time. As an example, the user may have to hold the second wrist 204 in the side palm position with thumb up for two seconds to invoke the menu. This predetermined holding threshold is helpful in avoiding the unintended display of the menu if the user is attempting to rotate the second wrist 204 through the side palm position with thumb up to attain a double palm rotation. In another embodiment, the predetermined holding threshold may be utilized for other of the predetermined rotational orientations. For example, a predetermined holding threshold may be utilized for the selection of an object, double palming, etc.

The processor operably connected with the computing device 320 may keep track of the elapsed time to determine if the menu is invoked. Alternatively, a processor associated with the rotational sensor 108 may keep track of the elapsed time to determine whether or not to send a request to the computing device 320 to invoke the menu.

FIG. 3M illustrates the interactive system 300 in which the user utilizes the two wrist user input system to scroll through a window. As an example, the user may have the pointer 306 positioned in page one of a word processing window 314. The user may then wish to scroll down to page two of the word processing window 314.

FIG. 3N illustrates the interactive system 300 in which the user utilizes the two wrist user input system to scroll through a window of FIG. 3M. The user has turned the second wrist 204 into a palm up position with the pointer 306 positioned in page one of the word processing window. Keeping the second wrist 204 in the palm up position, the user moves the first wrist 202 downward to scroll to page two. In one embodiment, a scroll graphical display is displayed as the user performs the scrolling motion. If the user moves to the point where he or she would like to scroll down more, but the first wrist 202 is out of room to move downward, the user turns the second wrist 204 out of the palm up position, moves the first wrist 202 back into a position where the use has room to move downwards, and then moves the second wrist 204 back into the palm down position.

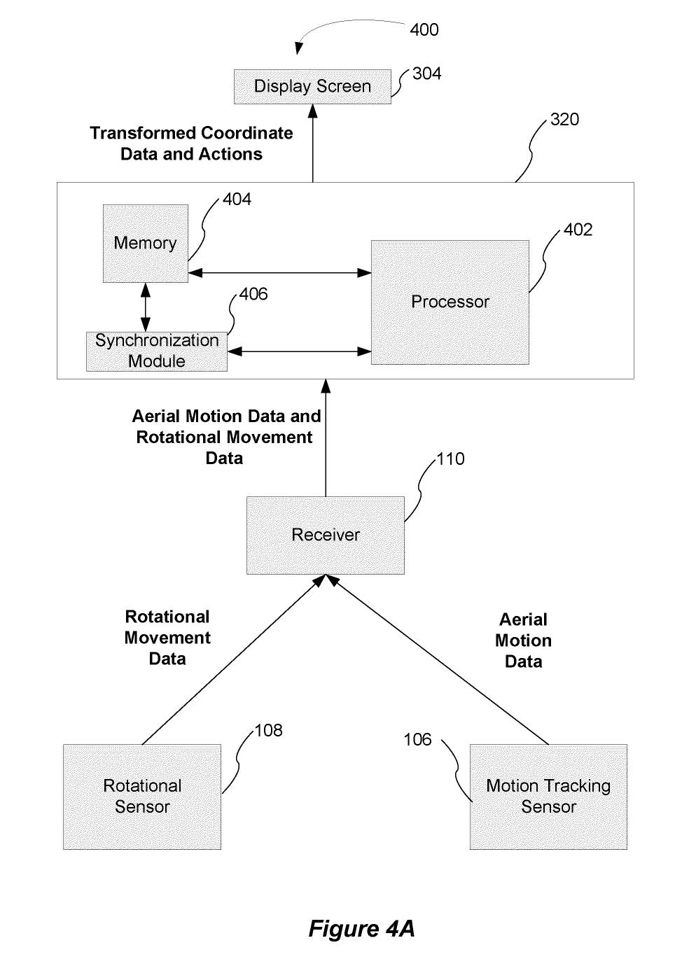

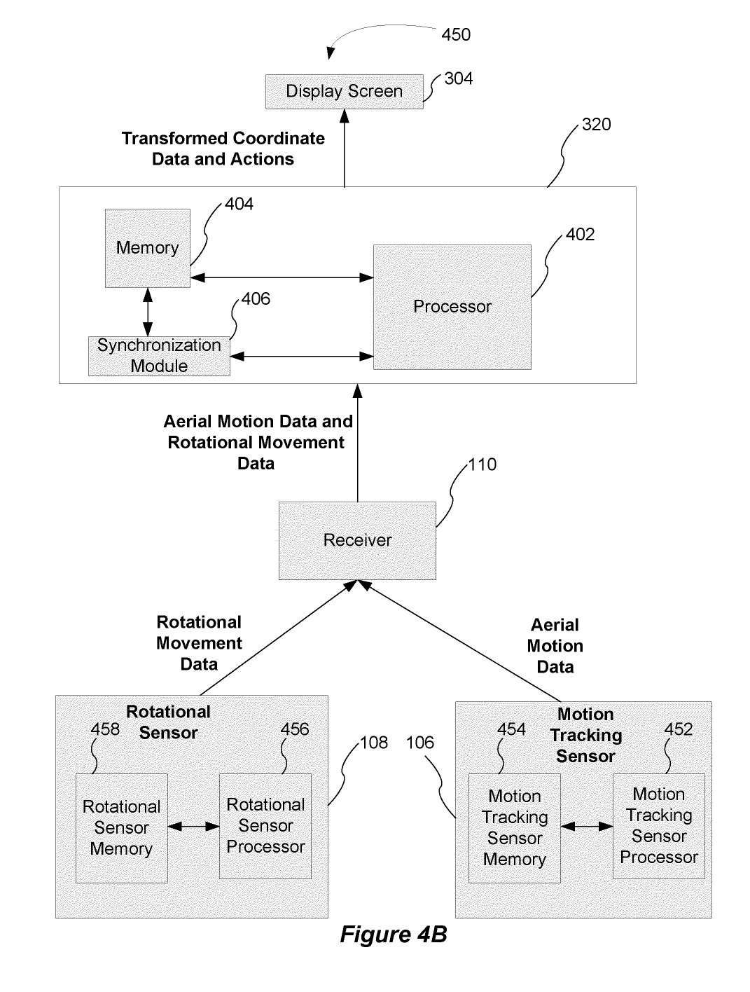

FIG. 4A illustrates a block diagram 400 of a configuration for the two wrist input system. The motion tracking sensor 106 sends the aerial motion data to the receiver 110, and the rotational sensor 108 sends the rotational movement data to the receiver 110. In another embodiment, one of the sensor may send data to the other sensor so that both sets of data are sent to the receiver 110 from one sensor. The receiver 110 sends the aerial motion data and the rotational movement data to the computing device 320, which has a processor 402 and a memory 404. The aerial motion data and the rotational movement data may be stored in the memory 404. The processor 402 processes the aerial motion data and the rotational movement data. For example, the processor 402 transforms the aerial motion data to the coordinate system of the display screen 304 and determines if any actions are to be taken based upon the rotational movement data.

In one embodiment, the computing device 320 has a synchronization module 406. The processor utilizes the synchronization module 406 to synchronizes the aerial motion data and the rotational movement data. In one embodiment, the two sets of data each have time stamps so that the synchronization module 406 can ensure that actions by the second wrist 204 are paired up with motion of the first wrist 202. In an alternative embodiment, the processor 402 utilizes the synchronization module 406 to time stamp two sets of data as data is received for each set. In yet another embodiment, time stamping is not utilized. The synchronization module 406 simply pairs up the two data sets as the two data sets are received. The synchronization module 406 is optional.

FIG. 4B illustrates a block diagram 450 that is an alternative configuration for the two wrist input system to the configuration illustrated in FIG. 4A. In one embodiment, the motion tracking sensor 106 may have a motion tracking sensor processor 452 and a motion tracking sensor memory 454. The motion tracking sensor memory 454 may store aerial motion data that is receive by the motion tracking sensor 106. The motion tracking sensor processor 452 may retrieve the aerial motion data from the motion tracking sensor memory 454 and process that aerial motion data. For example, the motion tracking sensor processor 452 may transform the aerial motion data into coordinates of a plane. The processor 402 in the computing device 320 may then process that coordinate data into the specific coordinate plane of the display screen 304 after receiving the aerial motion data from the receiver 110, which receiver the aerial motion data from the motion tracking sensor. In an alternative configuration where a transceiver is utilized in place of the receiver 110, the transceiver may receive the coordinate plane specifics from the computing device 320 to provide to the motion tracking sensor. The motion tracking sensor processor 452 may then be able to perform more of the processing of the transformation of the aerial motion data into the coordinate plane of the display screen 304. In yet another embodiment, the computing device may also send the transceiver the coordinate information of the current position of the pointer 306 so that the motion tracking sensor processor 452 may fully process the aerial motion data. The fully processed aerial motion data is then simply provided to the transceiver, which then provides the fully processed aerial motion data to the computing device 320. The processor in the computing device 320 then can provide any changes to the coordinates of the cursor 306 to the display screen 320. For any of the configurations described herein, the term aerial motion data refers to fully processed, partially process, or completely unprocessed aerial motion data that the receiver 110 provides to the processor 402 in the computing device 320.

The rotational sensor memory 458 may store rotational movement data that is sensed by the rotational sensor 108. The rotational sensor processor 456 may retrieve the rotational movement data from the rotational sensor memory 458 and process that rotational movement data. For example, the rotational sensor memory 458 may also store a correspondence data structure that defines an action for a predetermined rotational orientation. A plurality of predetermined rotational orientations may each be defined with a corresponding action. The rotational sensor processor 456 processor may then retrieve the data structure and the rotational movement data and determine if the rotational movement data indicates that any predetermined rotational orientations have been performed by the user. If any predetermined rotational orientations have been performed, the rotational sensor processor 456 determines what action is to be performed. The rotational sensor processor 456 may then simply send the action to be performed to the receiver so that the processor 402 in the computing device 320 may simply send the action to the display screen 304 without having to have knowledge of how the predetermined rotational orientations are defined as would be stored in the memory 404 for the configuration in FIG. 4A. Irrespective of whether the rotational movement data is processed into actions or includes specific data for rotations, the term rotational movement data is utilized as the data and/or actions are based on the rotation of the second wrist 204 of the user. Further, a synchronization module 406 may optionally be utilized as described with respect to FIG. 4A.

In an alternative embodiment, a combination of some of components from FIG. 4A and FIG. 4B may be utilized. For example, the rotational sensor 108 may have the rotational sensor processor 456 and the rotational sensor memory 458, and the aerial motion tracking sensor 106 may not have the motion tracking sensor processor 452 and the motion tracking sensor memory 454. Alternatively, the aerial motion tracking sensor 106 may have the motion tracking sensor processor 452 and the motion tracking sensor memory 454, and the rotational sensor 108 may not have the rotational sensor processor 456 and the rotational sensor memory 458. Further, if a processor is not present in a sensor, a memory may or may not be present.

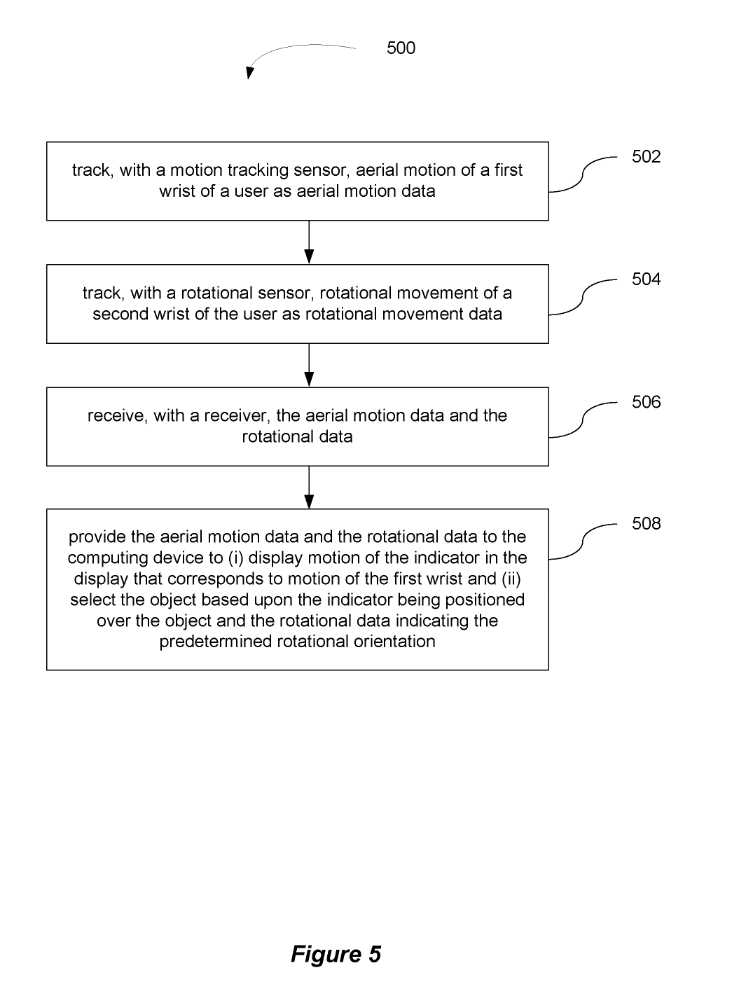

FIG. 5 illustrates a process 500 that may be utilized to provide user input. At a process block 502, the process 500 tracks, with a motion tracking sensor, aerial motion of a first wrist of a user as aerial motion data. The motion tracking sensor is adhered to a first wrist band that conforms to the first wrist of the user. The aerial motion of the first wrist of the user is performed by the user to move an indicator displayed a display screen operably connected with a computing device. Further, at a process block 504, the process 500 tracks, with a rotational sensor, rotational movement of a second wrist of the user as rotational movement data, the rotational sensor adhered to a second wrist band, the rotational movement of the second wrist of the user performed by the user to select, with a predetermined rotational orientation, an object over which the indicator is positioned as displayed by the display screen. The second wrist band conforms to the second wrist of the user. The second wrist is distinct from the first wrist. In addition, at a process block 506, the process 500 receives, with a receiver, the aerial motion data and the rotational data. At a process block 508, the process 500 provides the aerial motion data and the rotational data to the computing device to (i) display motion of the indicator in the display that corresponds to motion of the first wrist and (ii) select the object based upon the indicator being positioned over the object and the rotational data indicating the predetermined rotational orientation.

In another embodiment, a computer program product is provided. The computer program product includes a computer usable medium having a computer readable program. The computer readable program when executed on a computer causes the computer to track, with a motion tracking sensor, aerial motion of a first wrist of a user as aerial motion data. The motion tracking sensor is adhered to a first wrist band that conforms to the first wrist of the user, the aerial motion of the first wrist of the user being performed by the user to move an indicator displayed a display screen operably connected with a computing device. Further, the computer readable program when executed on a computer causes the computer to track, with a rotational sensor, rotational movement of a second wrist of the user as rotational movement data. The rotational sensor is adhered to a second wrist band. The rotational movement of the second wrist of the user is performed by the user to select, with a predetermined rotational orientation, an object over which the indicator is positioned as displayed by the display screen. The second wrist band conforms to the second wrist of the user, the second wrist being distinct from the first wrist. In addition, computer readable program when executed on a computer causes the computer to receive, with a receiver, the aerial motion data and the rotational data. The computer readable program when executed on a computer also causes the computer to provide the aerial motion data and the rotational data to the computing device to (i) display motion of the indicator in the display that corresponds to motion of the first wrist and (ii) select the object based upon the indicator being positioned over the object and the rotational data indicating the predetermined rotational orientation.

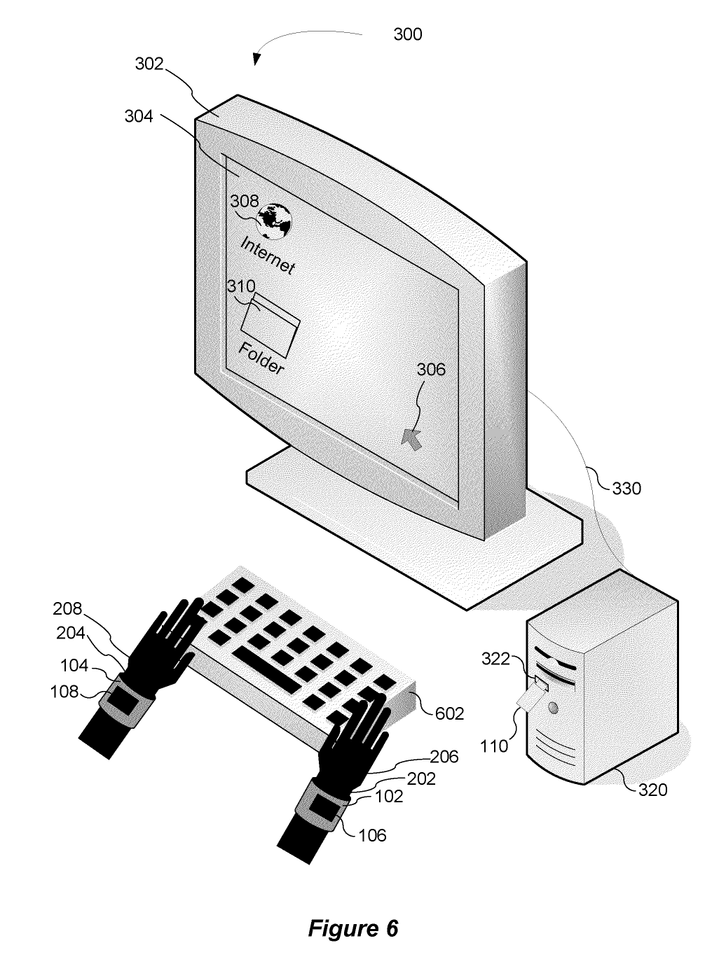

FIG. 6 illustrates the interactive system 300 of FIG. 3 with a keyboard 602. Any of the configurations provided herein have the ability to be utilized with other input devices such as the keyboard 602. The first wrist band 110 and the second wrist band 114 allow the user to comfortably work with the keyboard 602. For example, the wrist bands have the sensor positioned on the top of the wrist bands when the hands are in palm down positions. Accordingly, the user should be able to rest the bottoms of the wrist on the keyboard or a surface with comfort. Also, the user may comfortably and efficiently utilize the two wrist user input system with the keyboard 602. In contrast to a traditional computer mouse, the user may simply lift his or her hands off up off the keyboard a small distance to perform the movement described herein and then may let the fingers move downward a small distance to begin typing again. In contrast, a traditional mouse system typically requires the user to move at least one hand away from the keyboard and then back toward the keyboard numerous times. The two wrist input system reduces such inefficiencies.

In one embodiment, the two wrist input system is configured to minimize movement of the pointer 306 when typing. In one configuration, the processor 402 in the computing device 320 determines when an input is received from the keyboard 602. For a predetermined time period after receiving the input from the keyboard 602, the processor 402 basically ignores any motion data received from the motion tracking device for that predetermined time period. As an example, the predetermined time period may be half of a second. For instance, the user may press a button on the keyboard 602. For the next half second, the processor 402 in the computing device 320 ignores any motion tracking data received from the motion tracking device 106. Each time a button is pressed, the processor 402 restarts the predetermined time period. In other words, the previous predetermined time period is reduced and a new predetermined time period is initiated. Accordingly, after the last intended button of a plurality of buttons before pointer motion is intended is pressed, the processor 402 ignores only one half of a second of the motion data. In the instance where the predetermined time period is one half of a second, a user typing many buttons on the keyboard 602 should have very little motion of the pointer 306. Furthers, since the wrists typing on the keyboard 602 should be steady when typing with little movement, minimal motion of the pointer 306 should occur if the predetermined time period is not utilized. The example of one half of a second is intended only as an example.

The reduction of the predetermined time period resulting from a subsequent button being pressed is an example of a predetermined parameter being met. Other types of predetermined parameters may be utilized to reduce the predetermined time period. For example, if the user lifts the first wrist 202 at a certain acceleration the predetermined timer period may be reduced. For instance if the user presses a button on the keyboard 602, a predetermined time period of one half of a second may be initiated, but may be reduced to two tenths of a second if the user accelerates the second wrist 202 at an acceleration of fifteen inches per second. The user then may move the pointer 306. As another example, the predetermined parameter may be a certain vertical distance from the keyboard 602. For example, if the motion tracking sensor 106 senses that the user has moved the first wrist 202 a distance of three inches vertically from the keyboard 602, the predetermined time period may be reduced once the three inch distance is reached so that the user may move the pointer 306. The numerical values provided herein are intended only as examples for illustrative purposes. Further, various other predetermined parameters may be utilized.

In another embodiment, a switch may be positioned on one of the sensors, to temporarily stop transmission of the motion data. For example, when typing a large amount of text, movement of the pointer 306 may not be very necessary after initiation of the typing.

The rotational movement data is not as pertinent as the motion data during typing because the user is unlikely to rotate the second wrist 204 to a predetermined rotational orientation when typing in a palm down position. However, the processor 402 may also be configured to ignore the rotational movement data after receiving a typing input. Specifically, such a configuration may be helpful if a predetermined rotational orientation is configured for a small rotation from the palm down position.

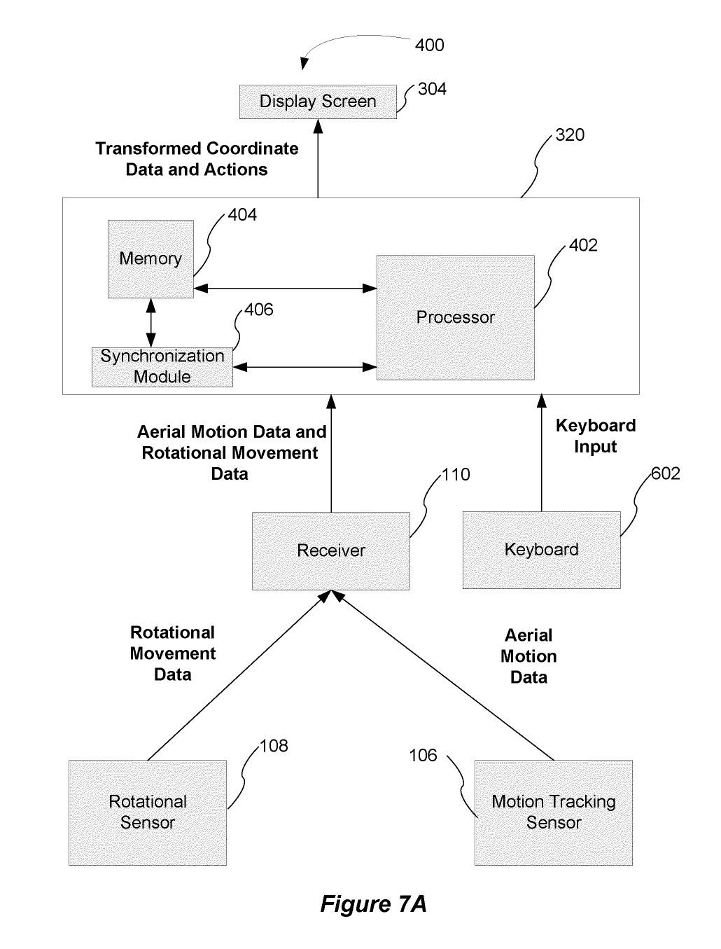

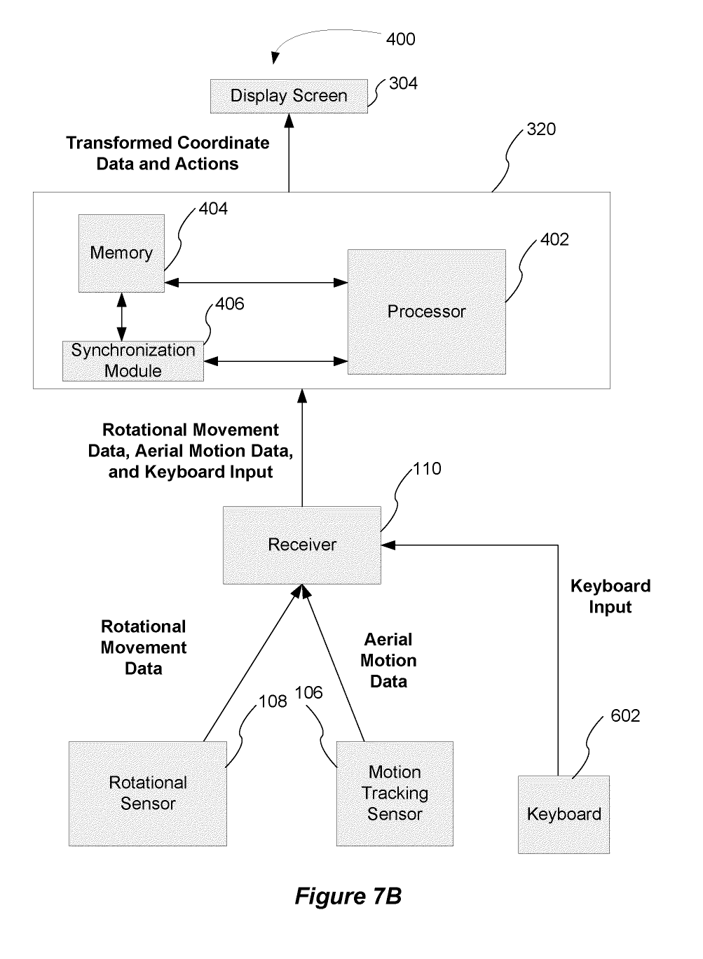

FIG. 7A illustrates the block diagram 400 illustrated in FIG. 4A with the keyboard 602 in direct communication with the computing device 320. In this configuration, the keyboard 602 provides the keyboard input data directly to the computing device 320. For example, the keyboard 602 may be directly connected to the computing device 320 via a cable. The processor 402 may utilize the synchronization module 406 to optionally synchronize the rotational movement data, the aerial motion data, and the keyboard input data to the computing device 320.

FIG. 7B illustrates the block diagram 400 illustrated in FIG. 4A with the keyboard 602 in communication with the receiver 110. The receiver may then send the rotational movement data, the aerial motion data, and the keyboard input data to the computing device 320. The processor 402 may utilize the synchronization module 406 to optionally synchronize the rotational movement data, the aerial motion data, and the keyboard input data to the computing device 320.

The block diagram 450 illustrated in FIG. 4B may also be utilized with a direct or an indirect communication with the keyboard 602. Further, the keyboard 602 may be utilized for some actions on a selected object. For example, the user may select an object with the two wrist user input system and decide to utilize the keyboard 602 shortcut to cut or past the object. Further, the user may utilize one or more buttons on the keyboard 602 in place to invoke a menu and possibly make a selection from the menu after the two wrist user input system is utilized to select the object.

The two wrist user input system may provide the user with the ability to select amongst different options provided herein. For example, a software program may allow the user change the orientation of the axes that are utilized for gathering motion data.

The actions described herein are intended only as examples. The two wrist user input system may be utilized for a variety of actions with a graphical display. For example, the two wrist user input system may be utilized to move a window, resize a window, zoom, etc. These actions would be performed in a similar many to any of the configurations described herein.

In one embodiment, the two wrist user input system may be utilized with a speech recognition software program that replaces input that would be performed by typing such as text input into a word processor. As a result, the user may be able to eliminate or almost completely eliminate use of the fingers to apply pressure to one or more actuators.

In an alternative embodiment, a single wrist user input system may be utilized with any of the configurations provided herein. The one wrist user input system may be utilized to provide data to a computing device instead of a traditional input system such as a mouse, trackball, touch pad, touch screen, etc. By utilizing natural movements of the hands rather than pressing an input device with one or more fingers, the one wrist user input system reduces the physical stress on the various joints of the fingers, hand, arm, shoulder, and neck. As a result, a user may increase the efficiency of providing input to a computing device. Further, the user may decrease the possibility of injury. The enjoyability of the overall user input experience may be enhanced. The one wrist user input system allows a user to make a motion with a hand in the direction of an object to be selected to move a pointer over that object and select the object without compromising the position of the pointer over the object when the selection of the object is made by the user.

The one wrist user input system positions both the motion tracking sensor 106 and the rotational sensor 108 one a single wrist. The rotational data cancels the motion tracking data upon if the rotational sensor 108 is in one or more predetermined rotational positions and/or is not in one or more predetermined rotational positions.

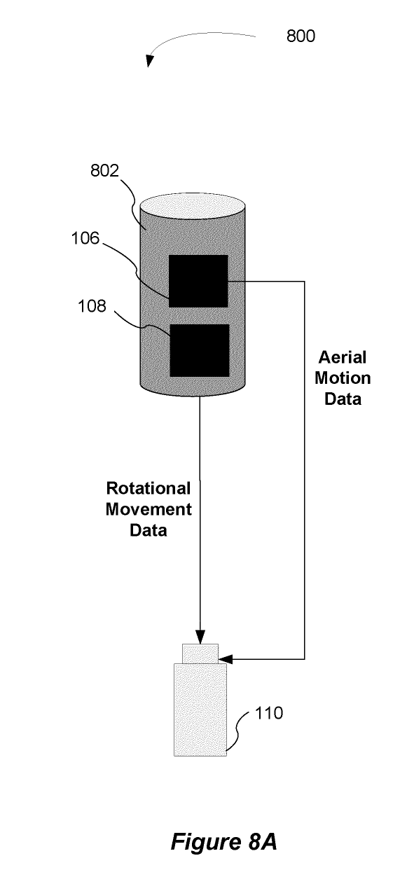

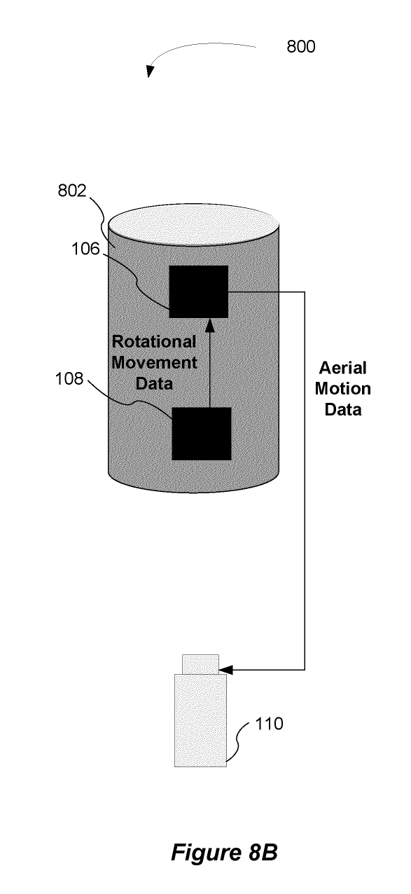

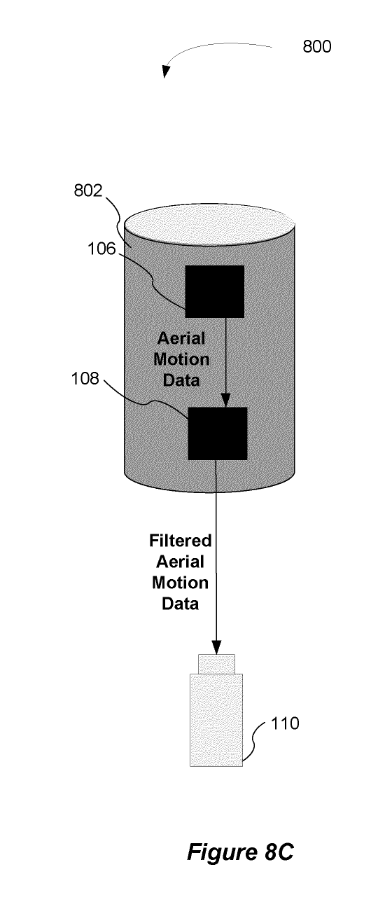

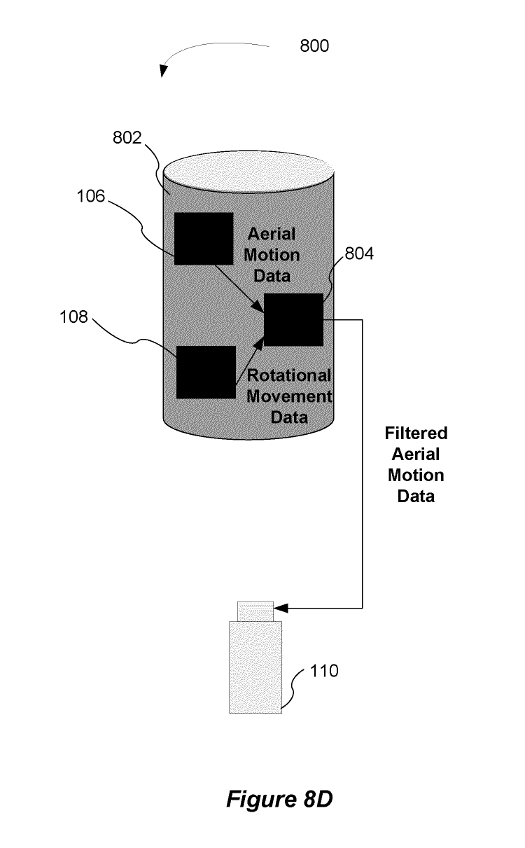

FIG. 8A illustrates a one user input configuration 800. In one embodiment, the one wrist user input configuration 800 includes a wrist band 802. The wrist band 802 has attached thereto the motion tracking sensor 106, which sends aerial motion data to a receiver 110, and the rotational sensor 108, which sends rotational movement data to the receiver 110. In one embodiment, the motion tracking sensor 106 and the rotational sensor 108 are attached in separate units to the wrist band 802. In another embodiment, the motion tracking sensor 106 and the rotational sensor 108 are attached in a single unit to the wrist band 802.

In one embodiment, the motion tracking sensor 106 is wireless and may send the aerial motion data to the receiver 110 through a wireless communication such as RF, IR, or the like. In another embodiment, the motion tracking sensor 106 is a wired device that may send the aerial motion data through a cable, cord, or the like to the receiver 110. The data communication between the motion tracking sensor 106 and the receiver 110 may be a local communication. In another embodiment, the data communication between the motion tracking sensor 106 and the receiver 110 may be a communication through a network.

In one embodiment, the rotational sensor 108 is wireless and may send the rotational movement data to the receiver 110 through a wireless communication such as RF, IR, or the like. In another embodiment, the rotational sensor 108 is a wired device that may send the rotational movement data through a cable, cord, or the like to the receiver 110. The data communication between the rotational sensor 108 and the receiver 110 may be a local communication. In another embodiment, the data communication between the rotational sensor 108 and the receiver 110 may be a communication through a network.

The receiver 110 may have the capability to receive wireless communications, hardwired communications, or both. Further, the receiver 110 may be configured to be operably connected to a computing device. As an example, the receiver may have a USB connector, a Serial connector, a Parallel connector, or the like. Alternatively, the receiver 110 may be built into the computing device.

In an alternative embodiment, two receivers may be utilized in place of the receiver 110. For example, a first receiver that receives the aerial motion data may be operably connected to a computing device and a second receiver that receives the rotational movement data may be operably connected to the computing device.

In yet another embodiment, the motion tracking sensor and the rotational sensor 108 may communicate with one another so that a single data stream is sent from the one of the sensor to the receiver 110. FIG. 8B illustrates the single wrist user input configuration 800 in which the aerial motion tracking sensor 106 may send aerial motion data to the receiver 110, but may only do so after if rotational movement data that the aerial motion tracking sensor receives and/or does not receive indicates that the aerial motion data for a given time period may be sent. FIG. 8C illustrates the single wrist user input configuration 800 in which the single data stream may be sent by the rotational sensor 108, which may receive the aerial motion tracking data from the motion tracking sensor 106 and filter aerial motion data to the receiver 110 for the aerial motion data for a given time period if the rotational data indicates and/or does not indicate one more predetermined rotational positions. FIG. 8D illustrates the single wrist user input configuration 800 in which the single data stream may be sent by a data filter 804. The data filter 804 receives the aerial motion data from the aerial motion tracking sensor 106 and the rotational movement data from the rotational sensor 108. The data filter generates a single data stream by filtering out aerial motion data that occurs within a given time period in which the rotational movement data indicates and/or does not indicate one or more predetermined rotational positions. In one embodiment, the data filter 804 is a processor. In another embodiment, the data filter 804 is a computer program that is a computer program executed by a processor.

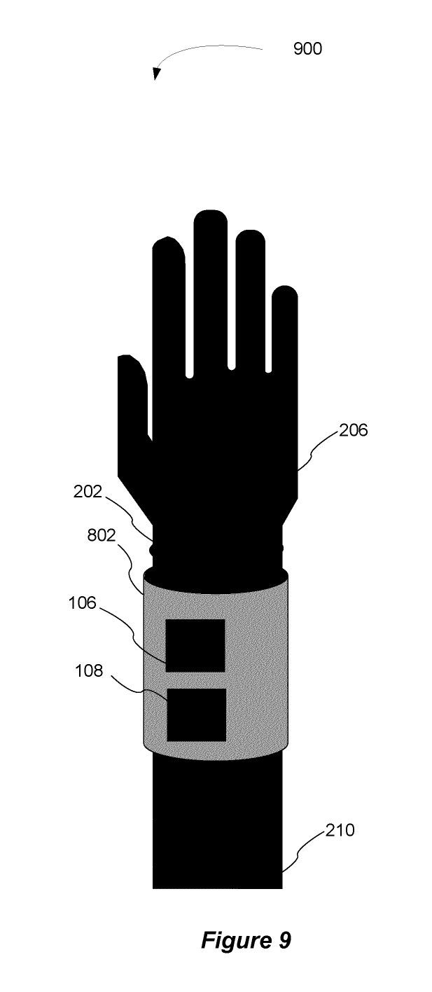

FIG. 9 illustrates the one wrist user input configuration 800 positioned on a wrist of the user. The wrist band 802 conforms to a first wrist 202 of the user. The term first wrist 202 is intended to include the portion of the arm of the user that extends from a first forearm 210 of the user to a first hand 206 of the user. In other words, the wrist band 802 may be positioned over the wrist joint, above the wrist joint by the first hand 206, beneath the wrist joint by the first forearm 210. In another embodiment, the wrist band 802 may be positioned on other parts of an arm of the user. The term arm is intended to include the limb from the shoulder joint down to the finger tips. For example, the wrist band 802 may be positioned over the upper part of the first forearm 210 that is proximate to the elbow joint, the upper arm between the elbow joint and the should joint, on the elbow joint, on the first hand 206, on one more fingers of the first hand 206, or the like.

The wrist band 802 may adhered to the first wrist 202 of the user with a connection mechanism such as a strap, a hook, or any other connection mechanism known to one of ordinary skill in the art. Alternatively, the wrist band 802 may slide on to the first wrist 202 of the user. In one embodiment, the wrist band 802 may be made of an elastic material. In one embodiment, the motion tracking sensor 106 and the rotational sensor 108 are adhered to the wrist band 802 such that when the user positions the wrist band 802 on his or her first wrist 202, the motion tracking sensor 106 and the rotational sensor are situated on top of the first wrist 202 when the first wrist 202 is in a palm down position. With the motion tracking sensor 106 and the rotational sensor 108 positioned on the top of the wrist band 802, the user may perform other tasks, e.g., typing, writing, etc., comfortably as the bottom of the first wrist 102 would likely engage a surface such as a desk to perform those other tasks. The motion tracking sensor 106 and the rotational sensor 108 may be adhered to the wrist band 802 by any adhering mechanism or methodology known to one of ordinary skill in the art. The term adhere is intended for any of the configurations described herein to mean adhered to the external surface or internal surface an item. As an example, the wrist band 802 may have a single holder to hold the motion tracking sensor 106 and the rotational sensor 108. As another example, the wrist band 802 may have separate holders to hold the motion tracking sensor 106 and the rotational sensor 108. Further, if another device such as the data filter 804 is utilized, a single holder or a separate holder may be utilized for the data filter 804.

In yet another embodiment, a different type of holding mechanism may be utilized for the motion tracking sensor 106 and the rotational sensor 108. For example, a glove, clothing, etc. may be utilized in place of the wrist band 802. The motion tracking sensor 106 and the rotational sensor 108 may be adhered to a ring. For example, the motion tracking sensor 106 and the rotational sensor 108 may be attached to a ring or may be built into the ring itself. Any of these configurations may also be utilized to position the data filter 804.

In another embodiment, the motion tracking sensor 106 and the rotational sensor do not have to be adhered to the wrist band 802 or any other holding mechanism. For example, the motion tracking sensor 106 and the rotational sensor may have a clip that adheres to a watch, bracelet, or the like. Alternatively, a clip that is separate from the motion tracking sensor 106 and the rotational sensor 108 may be utilized to adhere the motion tracking sensor 106 and the rotational sensor 108 to the watch, jewelry, or the like. Alternatively, the motion tracking sensor 106 and the rotational sensor 108 may simply be held in the first hand 206 of the user without being adhered to the user. Any of these configurations may also be utilized to position the data filter 804.

Although the sensors are illustrated as being positioned on top of the wrist band 802 for comfortability, the sensors may be placed on the sides, bottoms, or any other portion of the wrist band 802. The predetermined rotational orientations for the wrist band 802 may change as a result of such different positioning, but the user can then adapt the predetermined rotational orientations to conform with the different positioning of the rotational sensor 108. Although both sensors are shown as being on top of the wrist band 802, both sensors do not have to be in the same position. As an example, the rotational sensor 108 may be positioned on top of the wrist band 802 when the first hand 206 is in a palm down position and the motion tracking sensor 106 may be on the bottom of the wrist band 102 when the first hand 206 is in a palm down position.

The motion tracking sensor 106 for the single user input configuration 800 may track the aerial motion of the first wrist 202 of the user as aerial motion data according to any of the configurations provided for dual user input configuration 100. The single user input configuration 800 filters or cancels a portion of that aerial motion data according the rotational movement data indicating that the first wrist 202 is and/or is not in one or more predetermined rotational orientations. The filtering or canceling of a portion of the aerial motion data minimizes and possibly prevents motion of a pointer over an object after the user has positioned the pointer over the object through motion of the first wrist 202 and rotates the wrist to select the object. In other words, the single user input configuration 800 minimizes and possibly prevents motion of the pointer over the object that would otherwise occur if the user rotated his or her hand to make the selection. For example, the user may move his or her hand to the right to motion the pointer over an icon. After the pointer is positioned over the icon, the user may wish to select the icon by rotating his or her wrist to a palm up position. That rotation of that same wrist would otherwise lead to the pointer moving off of the object before the wrist of the user is in the palm up position to select the object. As a result, the pointer may not be pointing to anything or possibly even a different object by the time that the user has positioned his or her wrist in the palm up position. In such a situation, the user may not obtain the intended selection. In one embodiment, the single user input configuration 800 may filter out the rotational movement so that the pointer does not move as the wrist is rotating. For example, the single user input configuration 800 may filter out aerial motion data that coincides in a time period with rotational movement that indicates that the first wrist 202 is not in a predetermined rotational position such as a palm down position. As soon as the user slightly rotates his or her first wrist 202, the pointer may stop moving to allow a rotation for a selection by the user of an object over which the pointer is positioned. One or more degrees of freedom may be established to allow for slight rotations of the first wrist so that the pointer does not stop moving based on slight rotations that are not intended by the user as an initiation of a predetermined rotational movement for a selection. As another example, the single user input configuration 800 may filter out aerial motion data that coincides in a time period with rotational movement that indicates that the first wrist 202 is in a predetermined rotational position such as a predetermined angle. For example, if the user rotates his or her hand to an angle of greater than ten degrees, the filtering may be initiated. The cancellation or the filtering may be effectuated by the aerial motion tracking device 106, the rotational sensor 108, the receiver 110, a processor associated with one of the sensors, a processor associated with both of the sensors, a processor operably connected to the computing device 320, or the like.

In one embodiment, with any of the configurations provided for the single wrist user input system 800, a correction system may be utilized to automatically move the pointer. For example, if a rotation of ten degrees is sensed, the single wrist user input system 800 may indicate that the pointer should be rotated in the reverse direction ten degrees.

The single wrist user input configuration 800 allows the user to utilize a single wrist, e.g., the first wrist 202, without the second wrist 204 to select an object and perform an action on that object. The user moves a pointer over the object and rotates his or her wrist to perform the action. The single wrist user input system 800 minimizes movement of the pointer during the rotation of the wrist of the user. In one embodiment, the aerial motion may begin after being filtered or cancelled after a predetermined rotational position has been reached, e.g., palm down. In another embodiment, the aerial motion may begin after being filtered or cancelled after a predetermined rotational position has been reached, e.g., palm down, for a predetermined time period, e.g., half of a second. For example, the user may wish to make an additional rotation of the wrist immediately after rotating back to the palm down position. The additional rotation back to the palm down position will not initiate aerial motion if the additional rotation occurs within the predetermined time period.

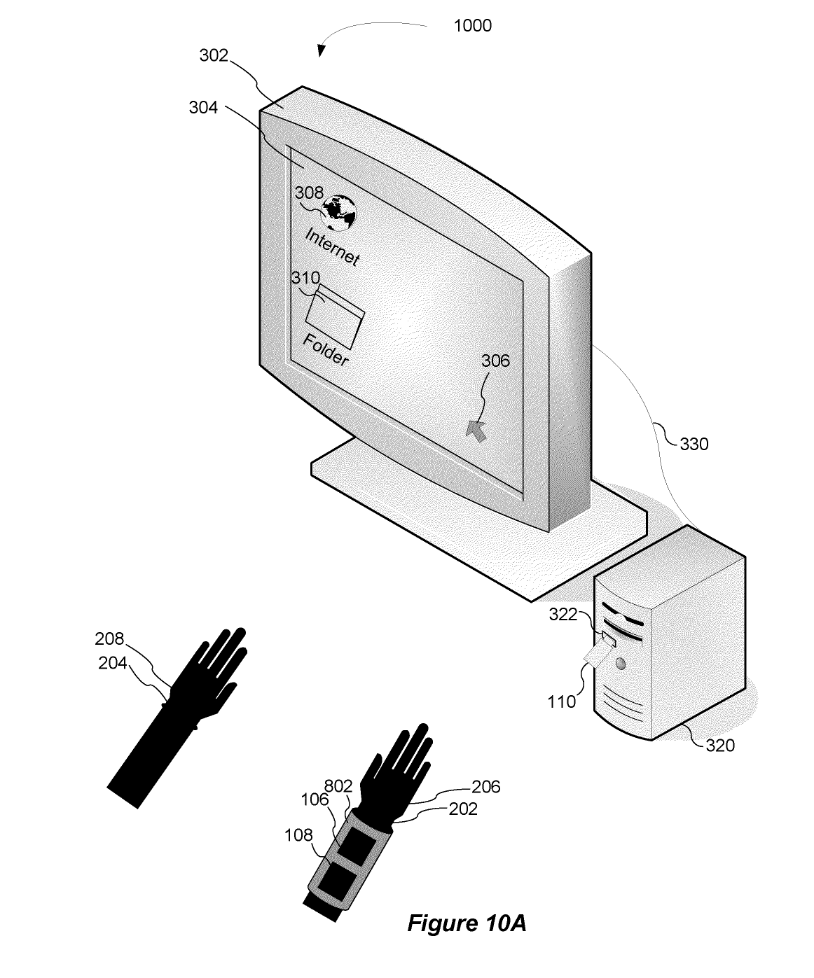

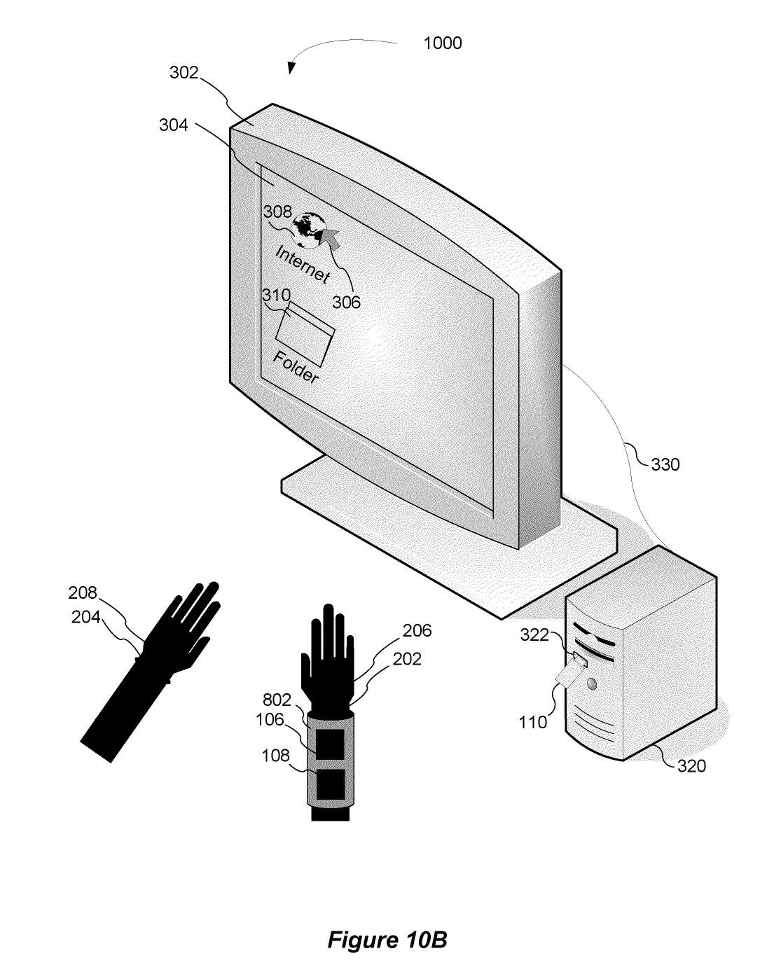

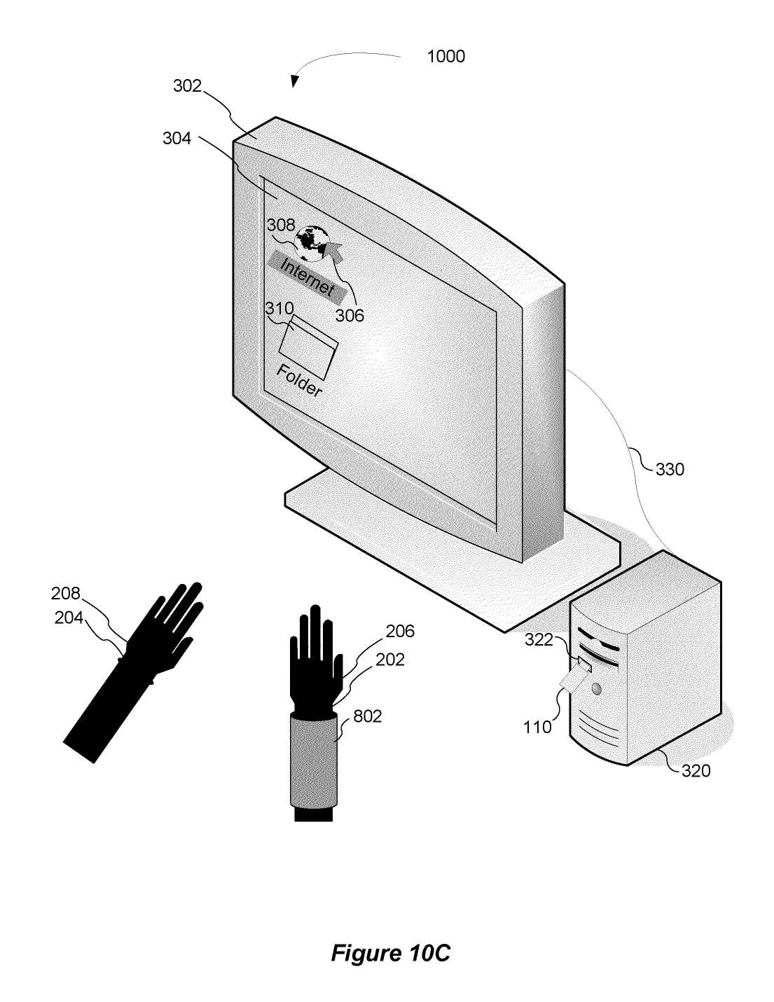

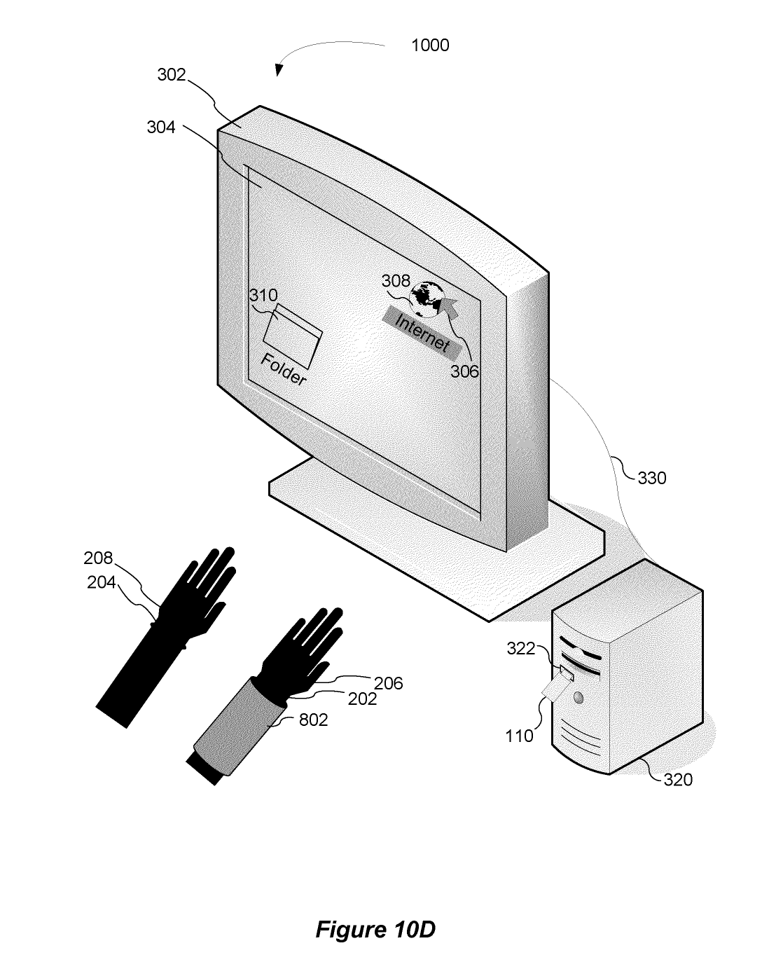

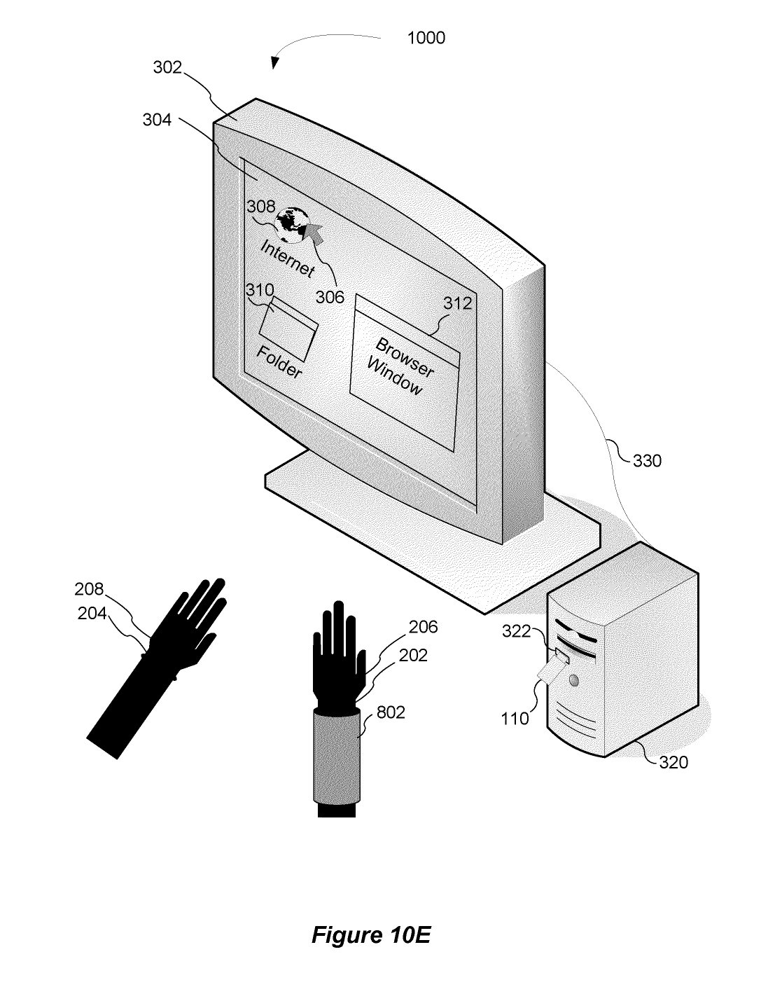

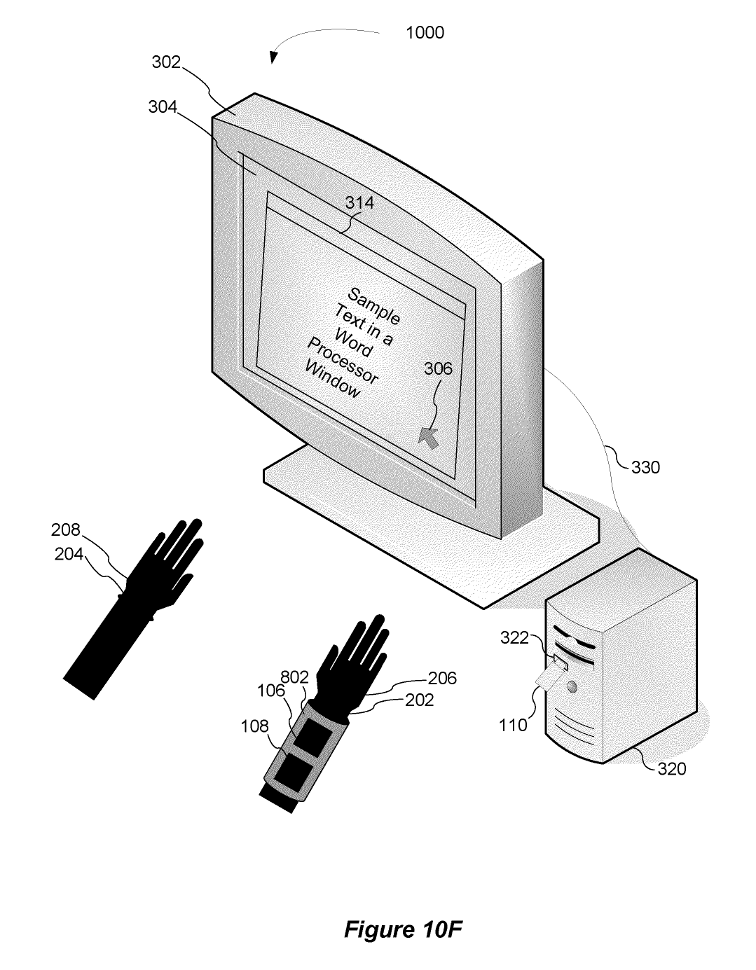

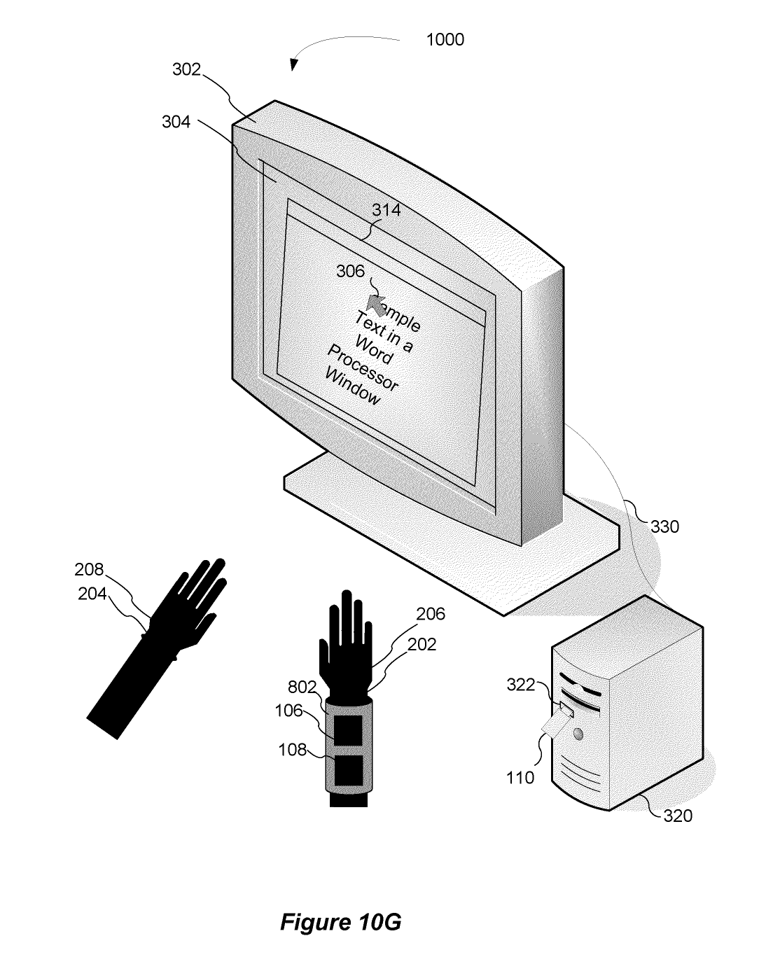

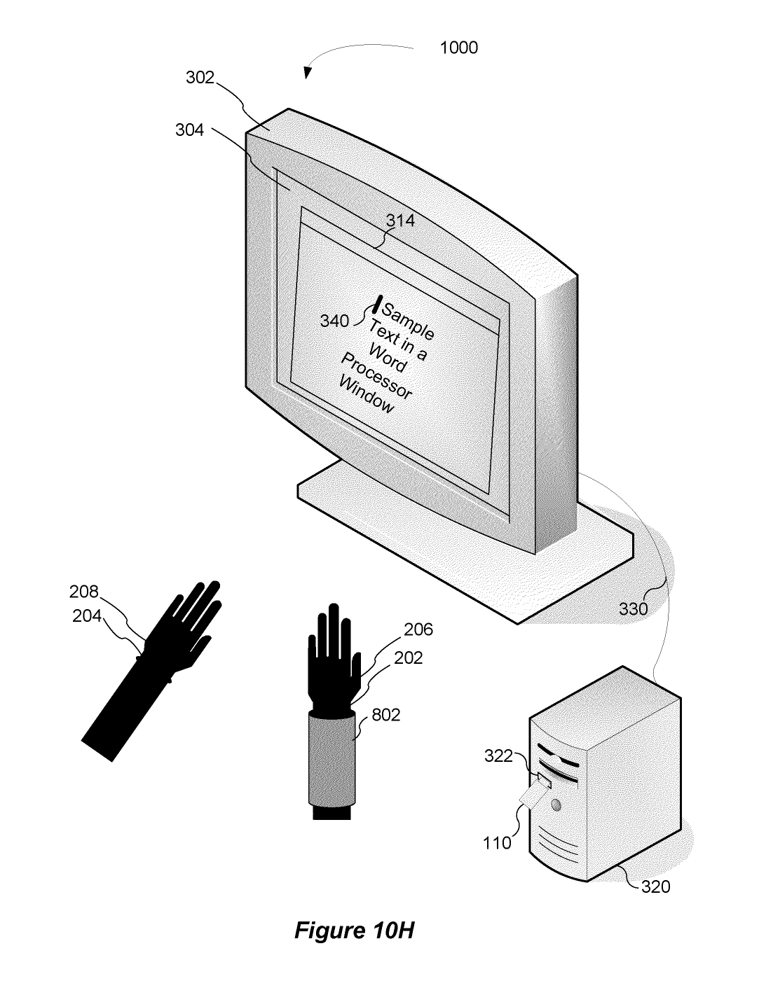

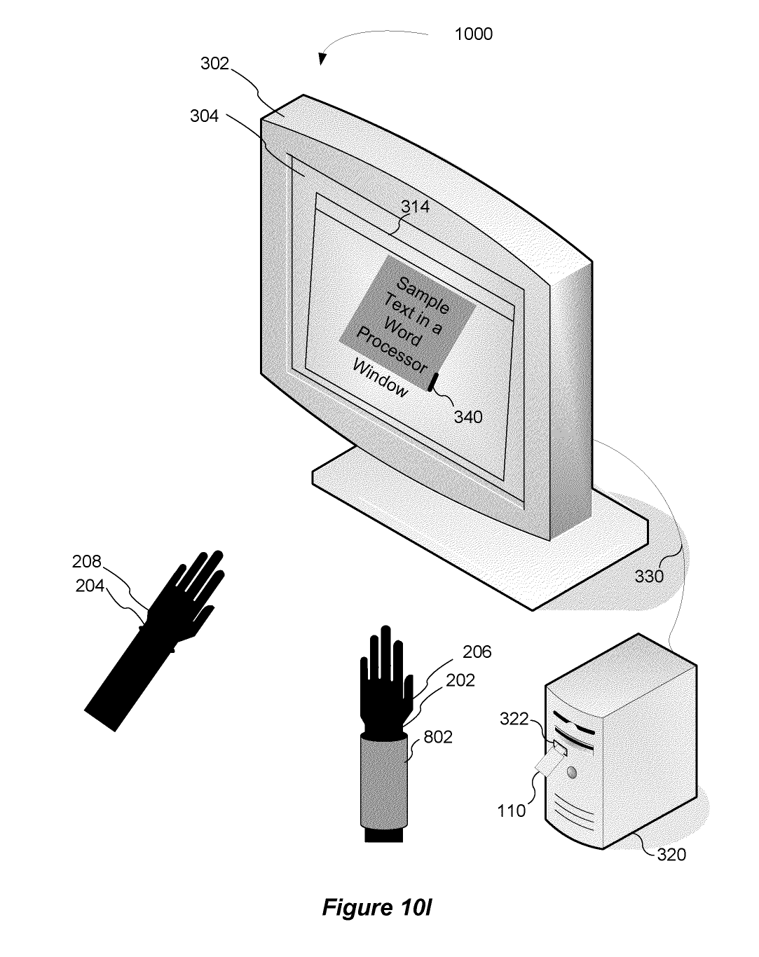

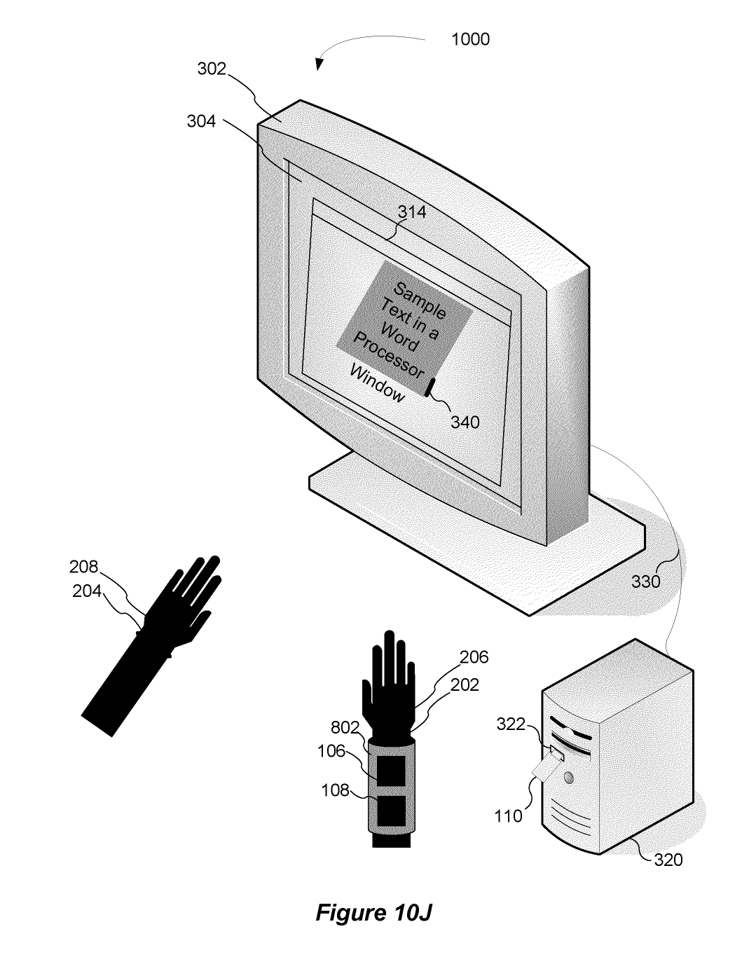

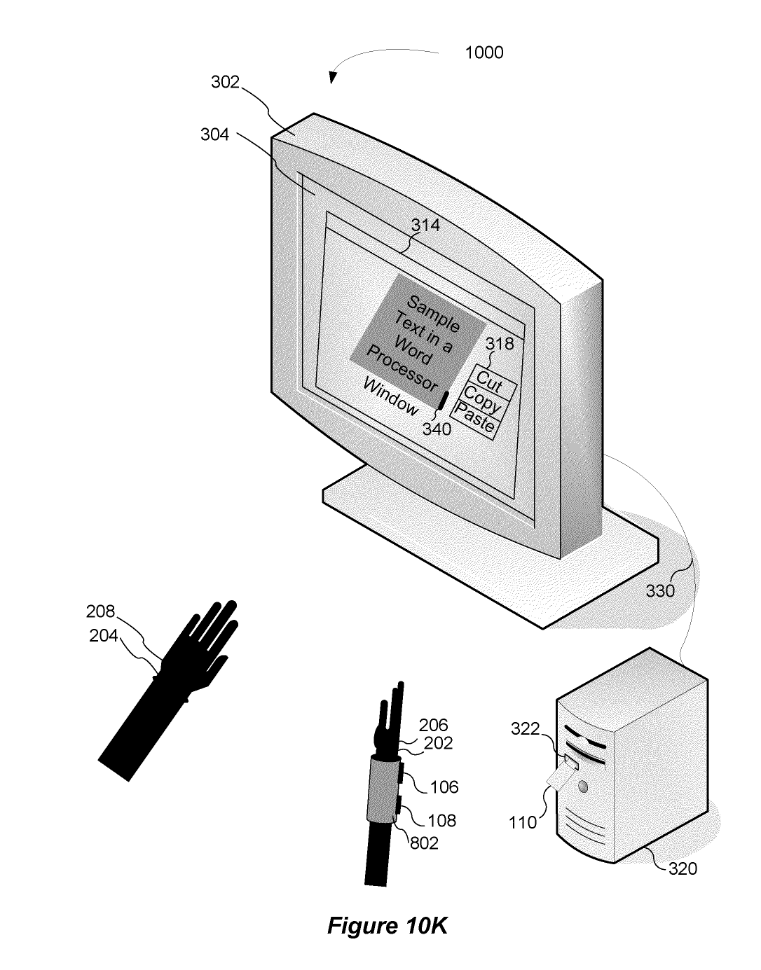

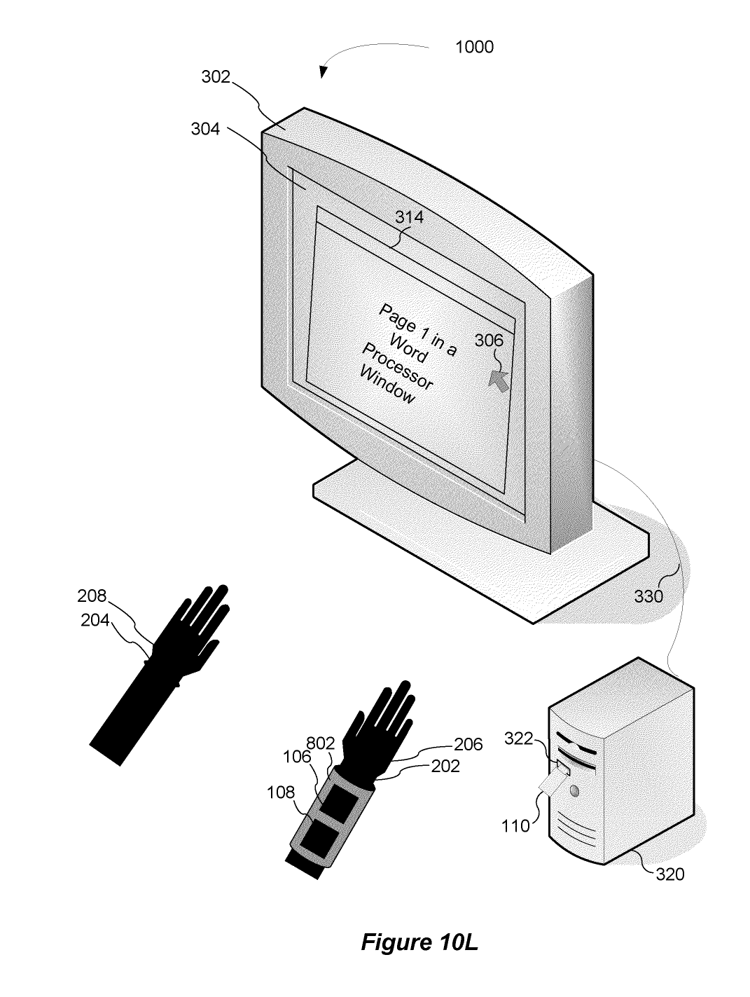

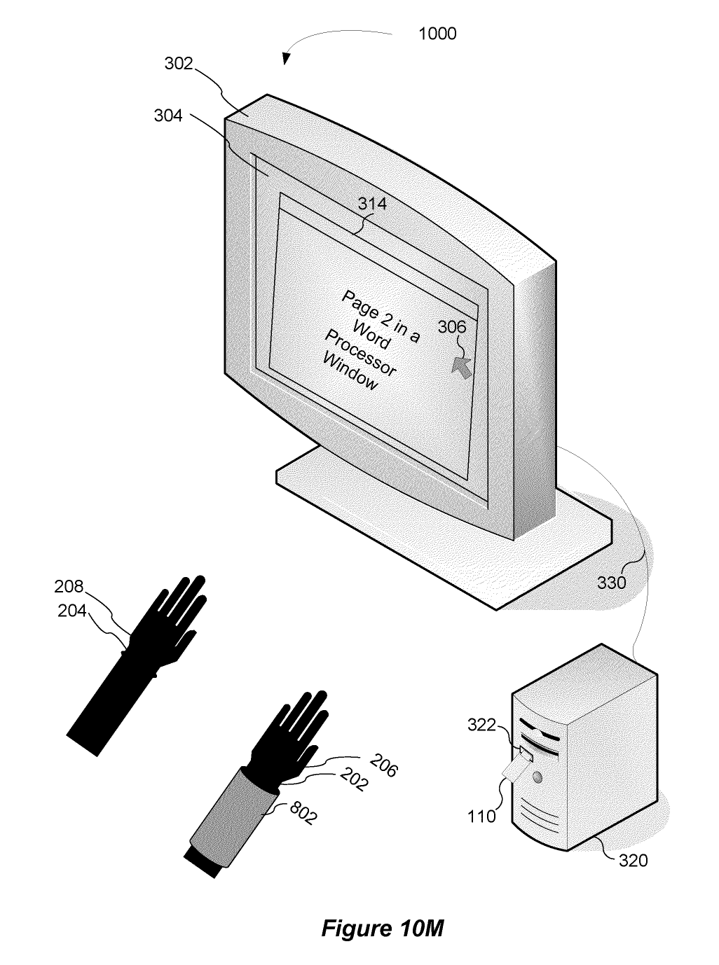

FIGS. 10A-10M illustrate a variety of actions that may be performed by the single wrist user input configuration 800. FIG. 10A illustrates an interactive system 1000. The wrist band 802 is attached to the first wrist 202. The second wrist 204 does not have to have anything attached thereto for operation of the single wrist user input configuration 800. Alternatively, the single wrist user input configuration 800 may be utilized with the second wrist 204 instead of the first wrist 202. FIG. 10B illustrates a motion of the first wrist 202 to position the pointer 306 over the Internet icon 308. FIG. 10C illustrates the first wrist 202 being in palm up position to make the selection of the Internet icon 308. When the user rotates the first wrist 202 to the palm up position, the pointer 306 does not move or moves a very small distance as the aerial motion data is filtered or cancelled based on the rotational sensor 108 sensing that the user is rotating the first wrist 202. Accordingly, the user can make an accurate selection of the Internet icon 308. FIG. 10D illustrates the movement of the icon 306 based on a movement of the first wrist 202 in the palm up position.

FIG. 10E illustrates the interactive system 1000 in which the user executes a computer program associated with the selected object illustrated in FIG. 10C. In one configuration, the user has turned the first wrist 202 to a palm up position to select the Internet icon 308 once the pointer 306 is positioned over the Internet icon 308. The user may then turn the first wrist 202 to a palm down position and then back to a palm up position in a predetermined amount of time to indicate that the Internet browser 312 associated with the Internet icon 308 should be invoked. As a result, a browser window 312 is displayed. In one embodiment, the pointer 306 does not move during these rotations as the rotational sensor 108 indicates that the first wrist 202 is rotating. In one embodiment, the first wrist 202 has to be in a predetermined rotational orientation for a predetermined time period, e.g. half of a second, for aerial motion to be reinitiated. Accordingly, the user may double palm without the pointer 306 being moved off of the Internet icon 308. In one embodiment, the time restriction would be imposed on the amount of time that the hand is in a predetermined orientation that allows for aerial motion. In other words, the user may move the hand in between double palms without a time restriction. In another embodiment, the user may not have to completely move the first wrist 202 to a palm down position between the palm up positions. An angle in between the palm up and palm down positions may be selected so that the user may perform the double palming more quickly.

In the configuration in which the object is already highlighted after the pointer 306 is positioned over the object for a predetermined period of time, the user may keep the pointer 306 positioned over the object and perform a single palm up movement to display the browser window 312. In the configuration in which no highlighting is required, the pointer 306 is simply positioned over the icon with the first wrist 202 and the first wrist 202 makes a single palm up motion to display the browser window 312. Any of these single palming configurations may be utilized to invoke computer code associated with an object.

After double palming or single palming to display the browser window 312, the user may turn the first wrist 202 to the palm down position to allow the pointer 306 to move freely. In any of the configurations provided herein, a degree of freedom may be provided so that the user may allow the pointer 306 to move freely if the wrist 202 is in an approximate, but not exact palm down position. For example, if the first wrist 202 is within fifteen degrees of a palm down position, the user may be able to move the pointer 306 freely.

FIG. 10F illustrates the interactive system 1000 in which the user utilizes the single wrist user input configuration 800 for word processing. The display 304 displays a word processing window 314. The single wrist user input system may be utilized not only to invoke a program such as a word processing program, but also to utilize such a program. The single wrist user input system may be utilized with other software applications such as spreadsheet programs, presentation programs, communication programs, computer aided design programs, or the like.

FIG. 10G illustrates the interactive system 1000 in which the user utilizes the single wrist user input system to edit text in the word processing window 314 of FIG. 10F. The user moves the first wrist 202 to move the pointer 306 to the beginning of the text.

FIG. 10H illustrates the interactive system 1000 in which the user utilizes the single wrist user input system to edit text in the word processing window 314 of FIG. 10G. The user turns the first wrist 202 to a palm up position to change the pointer 306 into a cursor 340. The user may turn the first wrist 202 out of the palm up position and back into the palm up position since the pointer 306 has already changed into a cursor.

FIG. 10I illustrates the interactive system 1000 in which the user utilizes the single wrist user input system to edit text in the word processing window 314 of FIG. 10H. The user may keep the first wrist 202 in the palm up position and move the first wrist 202 to the right and down to highlight some or all of the text.

FIG. 10J illustrates the interactive system 1000 in which the user utilizes the single wrist user input system to edit text in the word processing window 314 of FIG. 10I. The user turns the first wrist 202 back into the palm down position to end the highlighting of the text. In one configuration, the first wrist 202 may simply be turned out of the palm up position without having to go all the way back to the palm down position.

FIG. 10K illustrates the interactive system 1000 in which the user utilizes the single wrist user input system to edit text in the word processing window 314 of FIG. 3K. In one configuration, after the text has been highlighted, the user has turned the first wrist 202 into a palm down position as seen in FIG. 10J. The user now has a highlighted portion of text that may be edited. In one embodiment, the user may utilize a predetermined rotational orientation to invoke a menu 318 of possible actions that may be performed by the computing device with respect to the selected text. As an example, the user may turn the first wrist 202 into a side palm position such that the thumb is pointing up to invoke the menu 318. As an example, the rotational sensor 104 may have an electronic compass that senses an approximate position of west with a degree of freedom. Alternatively, the rotational sensor 108 may sense a thumb up position for a predetermined period of time after the palm up position to invoke the menu so that the user does not have to move the first wrist 202 all the way back to the palm down position prior to positioning the first wrist 202 in the thumb up position to invoke the menu. The two wrist input system may also utilize the rotational sensor 108 in this manner.

The utilization of this predetermined rotational orientation for the menu 318 is not limited to word processing. For example, in FIG. 10C, when the cursor 306 is positioned over the Internet icon 308 and the first wrist 202 is turned into a palm up position to select that icon, the user may turn the first wrist 202 into a palm down position and then into a side palm position with thumb up to invoke a menu of actions to perform on the Internet icon 308. In one embodiment, a time restriction for a predetermined amount of time is imposed for the side palm position with thumb up position after the selection with the palm down position. In another embodiment, no time restriction is imposed.

In one embodiment, the user has to hold the first wrist 202 in the side palm position with thumb up for a predetermined holding threshold to invoke the menu. The predetermined holding threshold is a predetermined amount of time. As an example, the user may have to hold the first wrist 202 in the side palm position with thumb up for two seconds to invoke the menu. This predetermined holding threshold is helpful in avoiding the unintended display of the menu if the user is attempting to rotate the first wrist 202 through the side palm position with thumb up to attain a double palm rotation. In another embodiment, the predetermined holding threshold may be utilized for other of the predetermined rotational orientations. For example, a predetermined holding threshold may be utilized for the selection of an object, double palming, etc.

The processor operably connected with the computing device 320 may keep track of the elapsed time to determine if the menu is invoked. Alternatively, a processor associated with the rotational sensor 108 may keep track of the elapsed time to determine whether or not to send a request to the computing device 320 to invoke the menu.

FIG. 10L illustrates the interactive system 1000 in which the user utilizes the single wrist user input system to scroll through a window. As an example, the user may have the pointer 306 positioned in page one of a word processing window 314. The user may then wish to scroll down to page two of the word processing window 314.

FIG. 10M illustrates the interactive system 1000 in which the user utilizes the single wrist user input system to scroll through a window of FIG. 3M. The user has turned the first wrist 202 into a palm up position with the pointer 306 positioned in page one of the word processing window 314. Keeping the first wrist 202 in the palm up position, the user moves the first wrist 202 downward to scroll to page two. In one embodiment, a scroll graphical display is displayed as the user performs the scrolling motion. If the user moves to the point where he or she would like to scroll down more, but the first wrist 202 is out of room to move downward, the user turns the first wrist 202 out of the palm up position, moves the first wrist 202 back into a position where the use has room to move downwards, and then moves the second wrist 204 back into the palm down position.

The block diagram 400 illustrated in FIG. 4A, the block diagram illustrated in FIG. 4B, a configuration that allows for a single data stream from one of the sensors to be sent to the receiver 110, or a similar configuration may be utilized to implement the single wrist user input system. In one embodiment, a cancellation or filtration mechanism is also implemented by the processor 402, the receiver 110, a processor that is associated with the receiver 110, e.g., the rotational sensor processor 456, the motion tracking sensor 106, a processor that is associated with the motion tracking sensor 106, e.g., the motion tracking sensor processor 452, the rotational sensor 108, a processor that is associated with the rotational sensor 108, a cancellation module that interacts with any one of these components, a cancellation module that is built into any one of these components, or the like.

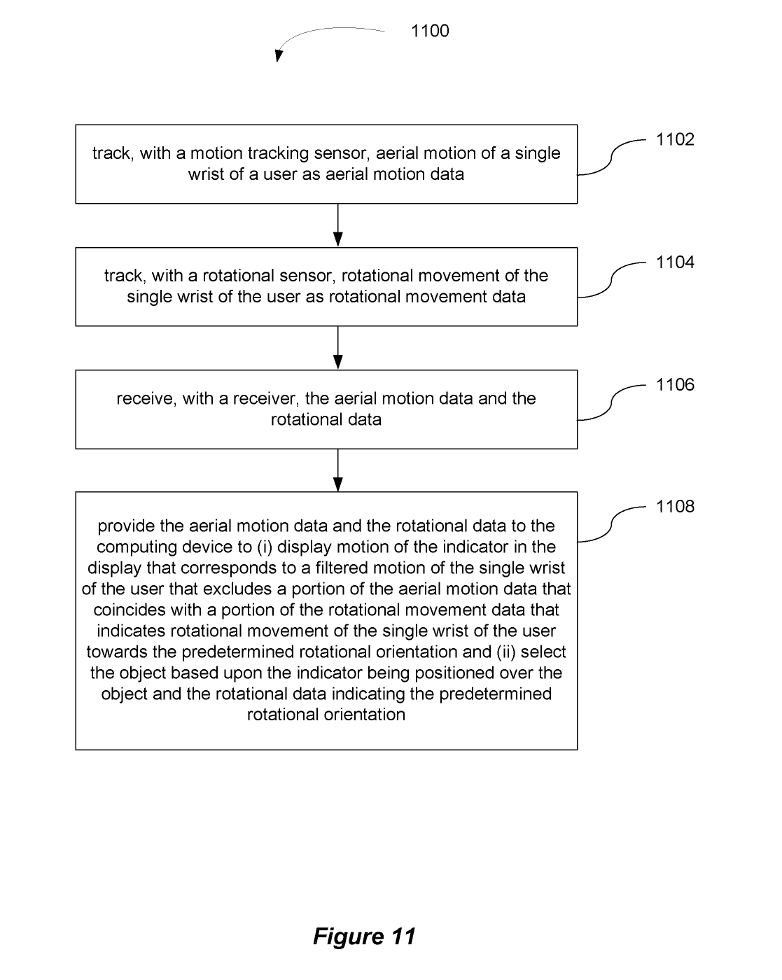

FIG. 11 illustrates a process 1100 that may be utilized to provide user input. At a process block 1102, the process 1100 tracks, with a motion tracking sensor, aerial motion of a single wrist of the user as aerial motion data. The motion tracking sensor is adhered to a wrist band that conforms to a single wrist of a user. The aerial motion of the single wrist of the user is performed by the user to move an indicator displayed by a display screen operably connected to a computing device. The motion tracking sensor includes a motion transmitter that transmits the aerial motion data. Further, at a process block 1104, the process 1100 tracks, with a rotational sensor, rotational movement of the single wrist of the user as rotational movement data. The rotational sensor is adhered to the wrist band. The rotational movement of the single wrist of the user is performed by the user to select, with a predetermined rotational orientation, an object over which the indicator is positioned as displayed by the display screen. The rotational sensor includes a rotational transmitter that transmits the rotational data. Further, at a process block 1106, the process 1100 receives, with a receiver, the aerial motion data and the rotational data. In addition, at a process block 1108, the process 1100 provides the aerial motion data and the rotational data to the computing device to (i) display motion of the indicator in the display that corresponds to a filtered motion of the single wrist of the user that excludes a portion of the aerial motion data that coincides with a portion of the rotational movement data that indicates rotational movement of the single wrist of the user towards the predetermined rotational orientation and (ii) select the object based upon the indicator being positioned over the object and the rotational data indicating the predetermined rotational orientation. In one embodiment, a predetermined threshold may be established to determine how much rotational movement of the single wrist of the user towards the predetermined rotational orientation is enough to filter the motion. For example, a threshold of five degrees may be enough so that very little movement of the pointer over the object occurs to keep the pointer over the object. A correction mechanism may or may not be utilized to move the pointer back the amount of the predetermined threshold, e.g., five degrees.

In an alternative embodiment, the object may be selected even if the pointer moves off of the object as the computer device may determine from the aerial motion data and the rotational movement data the object over which the pointer 306 was last positioned. Although filtering or cancellation is not needed for this embodiment, filtering or cancellation may help reduce the distance that the pointer moves from the object. Accordingly, filtering or cancellation may or may not be utilized for this embodiment.

The process 1100 may additionally or alternatively be utilized to display motion of the indicator in the display that corresponds to a filtered motion of the single wrist of the user that excludes a portion of the aerial motion data that coincides with a portion of the rotational movement data that indicates rotational movement of the single wrist of the user away from the predetermined rotational orientation. For example, after a user has single palmed to make a selection, the motion of the first 202 back towards a palm down position should also be filtered to be excluded from the filtered motion of the single wrist of the user as that motion should not move the pointer 306 off of the object. For example, the user may wish to perform further functions on the object and may wish that the pointer remain over the object until the first wrist is positioned over the object in a palm down position with a time restriction or without a time restriction. In one embodiment, a predetermined threshold may be established to determine how much rotational movement of the single wrist of the user away from the predetermined rotational orientation is enough to filter the motion. For example, a threshold of five degrees may be enough so that very little movement of the pointer over the object occurs to keep the pointer over the object. A correction mechanism may or may not be utilized to move the pointer back the amount of the predetermined threshold, e.g., five degrees.

The single wrist user input system may be utilized in conjunction with the keyboard 602 as illustrated in FIG. 6. Except for the utilization of one wrist instead of two wrists, the configurations described in FIGS. 6, 7A, and 7B may be utilized with the single wrist user input system to include a keyboard. Further other various components and features described with respect to the two wrist user input system may also be utilized with the single wrist user input system.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network.

A computer is herein intended to include any device that has a general, multi-purpose or single purpose processor as described above. For example, a computer may be personal computer (“PC”), laptop, computing tablet, a set top box (“STB”), cell phone, smart phone, portable media player, or the like.

Although particular examples of predetermined rotational orientations have been provided herein, other predetermined rotational orientations may be utilized. Further, the number of times that a predetermined rotational orientation is effectuated and resulting actions may vary from the examples provided herein.

It is understood that the processes and systems described herein may also be applied in other types of processes and systems. Those skilled in the art will appreciate that the various adaptations and modifications of the embodiments of the processes and systems described herein may be configured without departing from the scope and spirit of the present processes and systems. Therefore, it is to be understood that, within the scope of the appended claims, the present processes and systems may be practiced other than as specifically described herein.

I claim:

1. A single wrist user input system comprising:
a wrist band that conforms to a single wrist of a user;
a motion tracking sensor that tracks aerial motion of the single wrist of the user as aerial motion data, the motion tracking sensor being adhered to the wrist band, the aerial motion of the single wrist of the user performed by the user to move an indicator displayed by a display screen operably connected to a computing device, the motion tracking sensor including a motion transmitter that transmits the aerial motion data;
a rotational sensor that tracks rotational movement of the single wrist of the user as rotational movement data, the rotational sensor being adhered to the wrist band, the rotational movement of the single wrist of the user performed by the user to select, with a predetermined rotational orientation, an object over which the indicator is positioned as displayed by the display screen, the rotational sensor including a rotational transmitter that transmits the rotational data; and
a receiver that receives the aerial motion data and the rotational movement data to provide the aerial motion data and the rotational movement data to the computing device to (i) display motion of the indicator in the display that corresponds to a filtered motion of the single wrist of the user that excludes a portion of the aerial motion data that coincides with a portion of the rotational movement data that indicates rotational movement of the single wrist of the user towards the predetermined rotational orientation and (ii) select the object based upon the indicator being positioned over the object and the rotational data indicating the predetermined rotational orientation.

2. The single wrist input system of claim 1, wherein the indicator is a pointer.

3. The single wrist input system of claim 1, wherein the receiver receives a keyboard input from the user.

4. The single wrist input system of claim 3, wherein aerial motion data captured after a predetermined period of time is transformed without aerial motion data captured during the predetermined period of time being transformed, the predetermined time period being a predetermined amount of time after the keyboard input from the user.

5. The single wrist input system of claim 4, wherein the predetermined time period is reduced such that a portion of the aerial motion data captured during the predetermined period of time is transformed if the aerial motion data indicates a predetermined parameter has been met.

6. The single wrist input system of claim 1, wherein the aerial motion is measured according to a vertical axis that is parallel to the display screen.

7. The single wrist input system of claim 1, wherein the aerial motion is measured according to a vertical axis that is orthogonal to the display screen.

8. The single wrist input system of claim 1, wherein the predetermined rotational orientation is a palm up position if the rotational sensor is positioned on the top of the wrist in a palm down position.

9. The single wrist input system of claim 1, wherein the receiver is a USB device.

10. The single wrist input system of claim 1, wherein the receiver further provides the aerial motion data and the rotational data to a processor in the computing device to display motion of both the indicator and the object if the aerial motion data and the rotational movement data indicate that the first wrist is in the predetermined rotational orientation during motion of the first wrist.

11. The single wrist input system of claim 1, wherein computer code associated with the object is executed by the processor upon the selection of the object.

12. The single wrist input system of claim 1, wherein the object is selected for a selection predetermined period of time upon the object based upon the indicator being positioned over the object and the rotational data indicating the predetermined rotational orientation.

13. The single wrist input system of claim 12, wherein the object is selected for a predetermined period of time and computer code associated with the object is executed by the processor if the rotational movement data indicates that the first wrist rotated to a different rotational orientation other than the predetermined rotational orientation and subsequently back to the predetermined rotational orientation within the selection predetermined period of time.

14. The single wrist input system of claim 1, wherein the motion tracking sensor includes at least one accelerometer.

15. The single input system of claim 1, wherein the motion tracking sensor includes at least one gyroscope.

16. The single input system of claim 1, wherein the rotational sensor includes an electronic compass.

17. The single wrist input system of claim 1, wherein the rotational sensor includes at least one accelerometer.

18. The single wrist input system of claim 1, wherein the rotational sensor includes at least one gyroscope.

19. A method comprising:
tracking, with a motion tracking sensor, aerial motion of a single wrist of the user as aerial motion data, the motion tracking sensor being adhered to a wrist band that conforms to a single wrist of a user, the aerial motion of the single wrist of the user performed by the user to move an indicator displayed by a display screen operably connected to a computing device, the motion tracking sensor including a motion transmitter that transmits the aerial motion data;
tracking, with a rotational sensor, rotational movement of the single wrist of the user as rotational movement data, the rotational sensor being adhered to the wrist band, the rotational movement of the single wrist of the user performed by the user to select, with a predetermined rotational orientation, an object over which the indicator is positioned as displayed by the display screen, the rotational sensor including a rotational transmitter that transmits the rotational data; and
receiving, with a receiver, the aerial motion data and the rotational data; and
providing the aerial motion data and the rotational data to the computing device to (i) display motion of the indicator in the display that corresponds to a filtered motion of the single wrist of the user that excludes a portion of the aerial motion data that coincides with a portion of the rotational movement data that indicates rotational movement of the single wrist of the user towards the predetermined rotational orientation and (ii) select the object based upon the indicator being positioned over the object and the rotational data indicating the predetermined rotational orientation.

20. A single wrist user input system comprising:
a motion tracking sensor that tracks motion of a single wrist of a user as motion data, the motion tracking sensor being adhered to the single wrist of the user, the motion of the first wrist of the user performed by the user to move an indicator displayed by a display screen operably connected to a computing device;
a rotational sensor that tracks rotational movement of the single wrist of the user as rotational movement data, the rotational sensor being adhered to the single wrist of the user, the rotational movement of the single wrist of the user performed by the user to select, with a predetermined rotational orientation, an object over which the indicator is positioned as displayed by the display screen; and
a receiver that receives the motion data from the motion tracking device and the rotational data from the rotational sensor, the receiver providing the motion data and the rotational data to the computing device to (i) display motion of the indicator in the display that corresponds to a filtered motion of the single wrist of the user that excludes a portion of the aerial motion data that coincides with a portion of the rotational movement data that indicates rotational movement of the single wrist of the user towards the predetermined rotational orientation and (ii) select the object based upon the indicator being positioned over the object and the rotational data indicating the predetermined rotational orientation.
